(19) United States
(12) Patent Application Publication
(10) Pub. No.: US 2022/0358544 A1
(43) Pub. Date: Nov. 10, 2022

(54) COMMUNICATION APPARATUS, COMPUTER-READABLE STORAGE MEDIUM, AND SYSTEM

(71) Applicant: HONDA MOTOR CO.,LTD., Tokyo (JP)

(72) Inventors: Masaru OTAKA, Saitama (JP); Ryusuke TAMANAHA, Saitama (JP); Ryo SAIKI, Saitama (JP); Yusuke OI, Tokyo (JP); Takahiro IIJIMA, Tokyo (JP); Naoko IMAI, Saitama (JP)

(21) Appl. No.: 17/868,783

(22) Filed: Jul. 20, 2022

Related U.S. Application Data
(63) Continuation of application No. PCT/JP2020/008252, filed on Feb. 28, 2020.

(51) Int. Cl. G06Q 30/02; H04W 4/23; H04W 4/021; H04W 4/029

(52) U.S. Cl. CPC G06Q 30/0266; H04W 4/23; H04W 4/021; H04W 4/029; H04W 88/04

(57) ABSTRACT

Provided is a communication apparatus including: a position information acquisition unit configured to acquire moving object position information regarding a current position of a first moving object on which the communication apparatus is mounted; a reception unit configured to receive distribution information; a transmission unit configured to transmit the distribution information to a second moving object; and a communication relay unit configured to relay communication between an external terminal and an external network. The distribution information includes distribution region information regarding a distribution region to which an advertisement is distributed, the transmission unit transmits the distribution information to the second moving object when the position indicated by the moving object position information is included in the distribution region, and the communication relay unit transmits the distribution information to the external terminal when the position indicated by the moving object position information is included in the distribution region.

The contents of the following Japanese patent application(s) are incorporated herein by reference:

NO. PCT/JP2020/008252 filed in WO on Feb. 28, 2020

### BACKGROUND

### 1. Technical Field

The present invention relates to a communication apparatus, a computer-readable storage medium, and a system.

### 2. Related Art

Patent Document 1 describes that an autonomous vehicle such as a UAV or an automobile provides a network access point. Patent Document 2 discloses a system that receives data from an in-vehicle occupant sensing system of a vehicle, analyzes the data, and presents an advertisement on an advertisement bulletin board display directed to an occupant of the vehicle.

### CITATION LIST

### Patent Document

Patent Document 1: Japanese translation publication of PCT route patent application No. 2019-521536
Patent Document 2: Japanese translation publication of PCT route patent application No. 2018-526749

### BRIEF DESCRIPTION OF THE DRAWINGS

FIG. 1 schematically illustrates an example of a system 10.

FIG. 2 schematically illustrates a conceptual view of advertisement distribution by the system 10.

FIG. 3 schematically illustrates an example of a functional configuration of a communication apparatus 400.

FIG. 4 schematically illustrates an example of a functional configuration of a communication terminal 500.

FIG. 5 schematically illustrates an example of a processing flow in the system 10.

FIG. 6 schematically illustrates an example of the processing flow in the system 10.

FIG. 7 schematically illustrates a report processing flow in the system 10.

FIG. 8 schematically illustrates a report processing flow in the system 10.

FIG. 9 is an explanatory diagram for explaining control processing of communication setting by a communication control unit 410.

FIG. 10 schematically illustrates an example of the processing flow in the system 10.

FIG. 11 illustrates an example of a flow of processing by the communication apparatus 400.

FIG. 12 illustrates an example of the flow of processing by the communication apparatus 400.

FIG. 13 schematically illustrates an example of a display area 602, an infection area 604, a non-infection area 606, and a sterilization area 608.

FIG. 14 schematically illustrates an example of a hardware configuration of a computer 1200 which functions as a server 100, the communication apparatus 400, or the communication terminal 500.

### DESCRIPTION OF EXEMPLARY EMBODIMENTS

Hereinafter, (some) embodiment(s) of the present invention will be described. The embodiment(s) do(es) not limit the invention according to the claims, and all the combinations of the features described in the embodiment(s) are not necessarily essential to means provided by aspects of the invention.

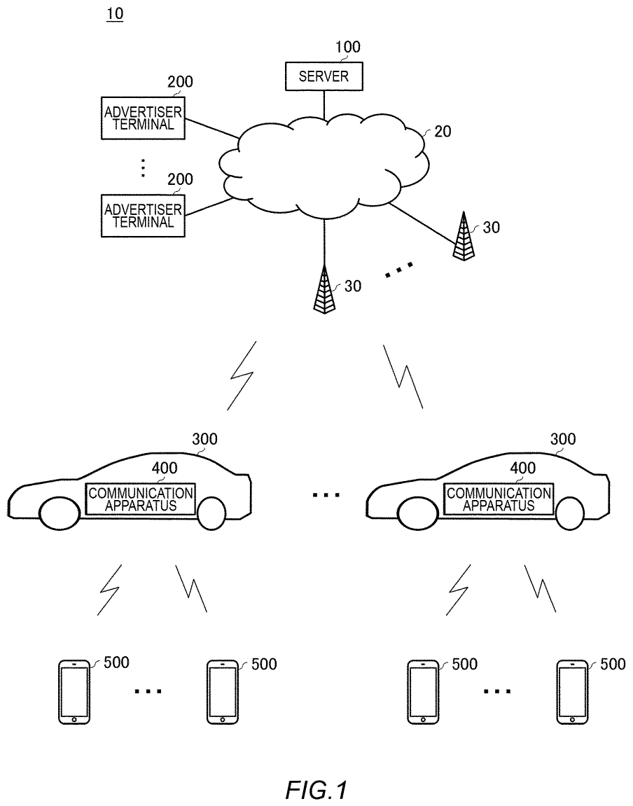

FIG. 1 schematically illustrates an example of a system 10. The system 10 includes a communication apparatus 400. The system 10 may include a vehicle 300. The system 10 may include a server 100. The System 10 may include an advertiser terminal 200. The system 10 may include a communication terminal 500.

The communication apparatus 400 is mounted on the vehicle 300. The vehicle 300 may be an example of a moving object. Examples of the moving object include an unmanned aerial vehicle and the like in addition to the vehicle 300.

The vehicle 300 may be an automobile. The vehicle 300 may be any type of automobile. The vehicle 300 may be a gasoline vehicle or may be a so-called eco-car. Examples of the type of eco-car include a hybrid vehicle (HV), a plug-in hybrid vehicle (PHEV/PHV), an electric vehicle (EV), a fuel cell vehicle (FCV) and the like. The vehicle 300 is, for example, a private car. Note that the vehicle 300 may be an automobile for any purpose. The vehicle 300 may be, for example, a business vehicle such as a taxi, a bus, and a moving stall. Furthermore, the vehicle 300 may be an autonomously traveling vehicle or may be a vehicle having an autonomous traveling mode.

The communication apparatus 400 has a so-called cellular communication function. An antenna for cellular communication may be included in the communication apparatus 400 or may be included in the vehicle 300 on which the communication apparatus 400 is mounted. The communication apparatus 400 establishes a wireless communication connection with a wireless base station 30 by using a cellular communication system, and accesses a network 20 via the wireless base station 30. The network 20 includes a cellular network. The network 20 may include the Internet. The network 20 may be an example of an external network.

The wireless base station 30 may be compliant with any cellular communication system. The wireless base station 30 is compliant with, for example, a long term evolution (LTE) communication system. The wireless base station 30 is compliant with, for example, a 3rd generation (3G) communication system. The wireless base station 30 is compliant with, for example, a 5th generation (5G) communication system. The wireless base station 30 is compliant with, for example, a 6th generation (6G) communication system and subsequent cellular communication systems. Here, a case where the wireless base station 30 is compliant with the LTE communication system will be mainly described as an example.

The communication apparatus 400 has a function of wirelessly communicating with the communication terminal 500. The communication apparatus 400 has, for example, a wireless fidelity (Wi-Fi (registered trademark)) communication function. An antenna for Wi-Fi communication may be provided in the communication apparatus 400, or may be provided in the vehicle 300 on which the communication apparatus 400 is mounted.

The communication terminal 500 may be any terminal having a wireless communication unit and a display unit. The communication terminal 500 is, for example, a mobile phone such as a smartphone. The communication terminal 500 may be a tablet terminal. The communication terminal 500 may be a wearable terminal such as a glasses-type device. The communication terminal 500 may be an example of an external terminal. Here, the outside of the moving object is not necessarily required to be the outside of the moving object, and the terminal may be used inside the moving object by being brought into the inside of the moving object. The communication terminal 500 only needs to be portable by an owner of the communication terminal 500 and to execute unique communication of the communication terminal 500 different from the content communicated by the communication apparatus 400.

The communication apparatus 400 has a function of directly communicating with another moving object. For example, the communication apparatus has a vehicle-to-vehicle communication function. The vehicle-to-vehicle communication may be an example of communication between moving objects. When the communication apparatus 400 is mounted on an unmanned aerial vehicle, the communication apparatus 400 may have a function of communicating between unmanned aerial vehicles.

The communication apparatus 400 can communicate with another communication apparatus 400 mounted on a vehicle 300 different from the vehicle 300 on which the communication apparatus 400 is mounted. The communication apparatus 400 communicates with another communication apparatus 400 by, for example, a dedicated short range communications (DSRC (registered trademark)) communication system. An antenna for DSRC may be included in the communication apparatus 400 or may be included in the vehicle 300 on which the communication apparatus 400 is mounted. The communication apparatus 400 may communicate with another communication apparatus 400 by a Wi-Fi communication system or a Bluetooth (registered trademark) communication system. Furthermore, the communication apparatus 400 can communicate with a roadside unit that has a communication function and is installed on a path. In this case, for example, the communication apparatus 400 may communicate with the roadside unit by a DSRC communication system, a Wi-Fi communication system, or a Bluetooth communication system.

The communication apparatus 400 has a communication relay function of relaying communication between the network 20 and the communication terminal 500. The communication apparatus 400 or the vehicle 300 may function as a so-called Wi-Fi hotspot. For example, the communication terminal 500 establishes a wireless communication connection with the communication apparatus 400 of the vehicle 300 being stopped or parked, to access the network 20 via the communication apparatus 400 and the wireless base station 30. The communication terminal 500 may establish a wireless communication connection with the communication apparatus 400 of the vehicle 300 that is traveling.

In this way, the communication apparatus 400 mounted on the vehicle 300 functions as a Wi-Fi hotspot, so that a Wi-Fi communication service can be provided to many communication terminals 500. However, in general, in the cellular communication between the communication apparatus 400 and the wireless base station 30, a pay-as-you-go system or a packet flat-rate system is adopted, and when no care is taken, the financial burden on a subscriber of the cellular communication and the owner of the vehicle 300 increases according to the relay amount of the communication.

On the other hand, the system 10 according to the present embodiment achieves an advertisement distribution service for the communication terminal 500 by the communication apparatus 400. For example, the server 100 receives a distribution request for distribution information from the advertiser terminal 200 and distributes the distribution information to the communication terminal 500 via the vehicle 300. The distribution information may be, for example, advertisement information or recommendation information. The advertiser terminal 200 may be a terminal used by an advertiser that desires to distribute the distribution information. The advertiser terminal 200 may be a mobile phone such as a smartphone, a tablet terminal, a personal computer (PC), or the like. Allocating the advertisement revenue to the owner of the vehicle 300 involved in the distribution of the distribution information allows giving the owner of the vehicle 300 an incentive to provide the Wi-Fi hotspot.

In particular, in the system 10 according to the present embodiment, the distribution information is transmitted to a specific vehicle 300 among a plurality of vehicles 300, and the distribution information is conveyed from the vehicle 300 to another vehicle 300 by the vehicle-to-vehicle communication. The vehicle-to-vehicle communication has a lower communication cost than the cellular communication. In general, in the vehicle-to-vehicle communication, a pay-as-you-go system or the like is not adopted, and thus the financial burden on the owner of the vehicle 300 does not increase even when a communication amount increases. Therefore, the communication cost can be reduced by using the vehicle-to-vehicle communication as compared with a case where the distribution information is transmitted from the server 100 to the plurality of vehicles 300 by the cellular communication.

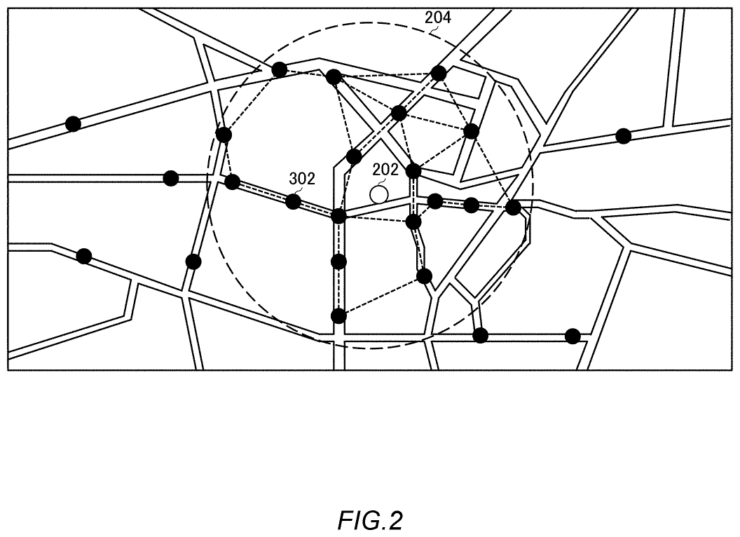

FIG. 2 schematically illustrates the conceptual view of advertisement distribution by the system 10. An advertisement base point 202 indicates a position related to advertisement. For example, when the advertiser is a store owner or the like, the advertisement base point 202 may indicate the position of the store. Furthermore, for example, when the advertiser is the promoter of an event, the advertisement base point 202 may indicate the venue of the event.

The advertisement base point 202 may indicate a geographic region related to the advertisement. For example, when the advertiser is a storeowner or the like, the advertisement base point 202 may indicate the geographic region of the store. Furthermore, for example, when the advertiser is the promoter of an event, the advertisement base point 202 may indicate the geographic region of the venue of the event.

An advertisement area 204 indicates an area where the advertiser desires to provide the distribution information, particularly, the advertisement. Although FIG. 2 illustrates a case where the advertisement area 204 is a circular area around the advertisement base point 202, the present invention is not limited thereto. The advertisement area 204 may be an area having any shape. Furthermore, the advertisement area may be a donut-shaped distribution region having a non-target region in the area. In this case, the region other than a target region in the area may include the advertisement base point 202. A vehicle position 302 indicates the position of the vehicle 300.

For example, the advertiser terminal 200 registers, in the server 100, advertisement content, the information of the advertisement base point 202, and the information of the advertisement area 204, and transmits the distribution request for the distribution information to the server 100. The advertisement content may include a text indicating the content of the advertisement. The advertisement content may include an image indicating the content of the advertisement. The advertisement content may include an audio related to content of the advertisement.

In response to the distribution request, the server 100 specifies, from the plurality of vehicles 300 in the advertisement area 204, one or more vehicles 300 to which the distribution information is to be transmitted. The server 100 specifies, for example, the vehicle 300 closer to the advertisement base point 202 among the plurality of vehicles 300. The server 100 may specify the vehicle 300 according to an instruction given by the advertiser using the advertiser terminal 200. Furthermore, the server 100 may specify the vehicle 300 based on the past record of the distribution of the distribution information of the vehicle 300.

The server 100 transmits the distribution information to the specified vehicle 300 via the network 20 and the wireless base station 30. The distribution information may include the advertisement content. The distribution information may include the information of the advertisement base point 202. The distribution information may include the information of the advertisement area 204.

The vehicle 300 that has received the distribution information conveys the distribution information to another vehicle 300 by vehicle-to-vehicle communication. The distribution information is conveyed, for example, between the vehicles 300 in the advertisement area 204.

The vehicle 300 that has received the distribution information transmits the distribution information to the communication terminal 500. The vehicle 300 may transmit the distribution information to the communication terminal 500 that has established the wireless communication connection. This allows the distribution information to be distributed to the communication terminal 500 positioned in the advertisement area 204.

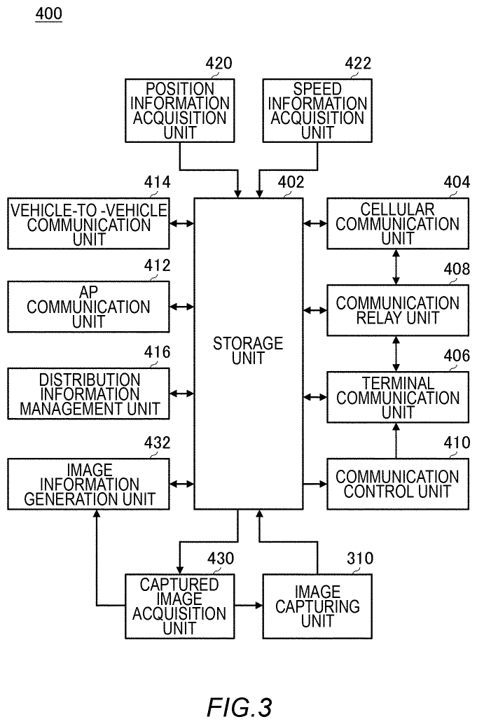

FIG. 3 schematically illustrates an example of the functional configuration of the communication apparatus 400. The communication apparatus 400 includes a storage unit 402, a cellular communication unit 404, a terminal communication unit 406, a communication relay unit 408, a communication control unit 410, an AP communication unit 412, a vehicle-to-vehicle communication unit 414, a distribution information management unit 416, a position information acquisition unit 420, a speed information acquisition unit 422, a captured image acquisition unit 430, and an image information generation unit 432. Note that it is not necessarily essential that the communication apparatus 400 includes all of these. Furthermore, a part of the configuration may be provided outside the communication apparatus 400, for example, in the vehicle 300.

The storage unit 402 stores various types of information. The storage unit 402 stores, for example, the distribution information. Furthermore, the storage unit 402 stores a captured image captured by an image capturing unit 310 included in the vehicle 300. The image capturing unit 310 is, for example, a drive recorder. The image capturing unit 310 may be the camera installed in the vehicle 300 separately from the drive recorder.

The cellular communication unit 404 wirelessly communicates with the wireless base station 30 by a cellular communication system. The cellular communication unit 404 accesses the network 20 via the wireless base station 30. The cellular communication unit 404 can receive the distribution information from the server 100 via the network 20 and the wireless base station 30, and store the distribution information in the storage unit 402. The cellular communication unit 404 may be an example of a reception unit which receives the distribution information.

The terminal communication unit 406 wirelessly communicates with the communication terminal 500 positioned outside the vehicle 300. The terminal communication unit 406 may wirelessly communicate with the communication terminal 500 positioned inside the vehicle 300. The terminal communication unit 406 may wirelessly communicate with the communication terminal 500 by the Wi-Fi communication system. The terminal communication unit 406 can transmit the distribution information stored in the storage unit 402 to the communication terminal 500. The terminal communication unit 406 may be an example of a transmission unit which transmits the distribution information to the communication terminal 500.

The communication relay unit 408 relays communication between the communication terminal 500 and the network 20. For example, the communication relay unit 408 transmits, to the network 20 via the cellular communication unit 404, data received by the terminal communication unit 406 from the communication terminal 500. For example, the communication relay unit 408 transmits, to the communication terminal 500 via the terminal communication unit 406, data received by the cellular communication unit 404 from the network 20. The communication relay unit 408 may transmit the distribution information to the communication terminal 500 via the terminal communication unit 406.

The communication control unit 410 controls communication setting for communication with the communication terminal 500. The communication control unit 410 controls, for example, a wireless communication area where the terminal communication unit 406 performs wireless communication with the communication terminal 500. As a specific example, the communication control unit 410 controls the size of the wireless communication area where the terminal communication unit 406 performs the wireless communication with the communication terminal 500. Furthermore, the communication control unit 410 controls, for example, the allowable number of connections for the terminal communication unit 406 to establish wireless communication connection with the communication terminal 500. Furthermore, the communication control unit 410 controls, for example, an allowable connection time for the terminal communication unit 406 to establish the wireless communication connection with the communication terminal 500. Furthermore, the communication control unit 410 controls, for example, on/off of the relay function by the communication relay unit 408.

The AP communication unit 412 wirelessly communicates with an access point. The AP communication unit 412 wirelessly communicates with, for example, Wi-Fi hotspots disposed in various places. The AP communication unit 412 may wirelessly communicate with free Wi-Fi hotspots disposed in various places. Furthermore, the AP communication unit 412 may wirelessly communicate with roadside units disposed in various places by the Wi-Fi communication system, the Bluetooth communication system, or the DSRC communication system. The roadside unit may be disposed in a traffic control system, for example, a traffic light.

The AP communication unit 412 may access the network 20 via the access point. The AP communication unit 412 can receive the distribution information from the server 100 via the network 20 and the access point and store the distribution information in the storage unit 402. The AP communication unit 412 may be an example of the reception unit which receives the distribution information.

The vehicle-to-vehicle communication unit 414 executes the vehicle-to-vehicle communication. The vehicle-to-vehicle communication unit 414 may communicate with another communication apparatus 400 by the DSRC communication system. The vehicle-to-vehicle communication unit 414 may communicate with another communication apparatus 400 by the Wi-Fi communication system. The vehicle-to-vehicle communication unit 414 may communicate with another communication apparatus 400 by the Bluetooth communication system. The vehicle-to-vehicle communication unit 414 can receive the distribution information from another communication apparatus 400 and store the distribution information in the storage unit 402. The vehicle-to-vehicle communication unit 414 may be an example of the reception unit which receives the distribution information. The vehicle-to-vehicle communication unit 414 can transmit the distribution information stored in the storage unit 402 to another communication apparatus 400. The vehicle-to-vehicle communication unit 414 may be an example of the transmission unit which transmits the distribution information to another vehicle.

The distribution information management unit 416 manages the distribution information stored in the storage unit 402. The distribution information management unit 416 edits the distribution information, for example.

The position information acquisition unit 420 acquires position information regarding the current position of the vehicle 300 (which may be described as a host vehicle) on which the communication apparatus 400 is mounted. The position information acquisition unit 420 acquires the position information of the host vehicle from, for example, the car navigation system of the host vehicle. When the communication apparatus 400 has a positioning function such as GPS positioning, the position information acquisition unit 420 may acquire a positioning result by the positioning function as the position information of the host vehicle.

The speed information acquisition unit 422 acquires speed information regarding the moving speed of the host vehicle. The speed information acquisition unit 422 may acquire speed information regarding the traveling speed of the host vehicle. The speed information acquisition unit 422 may acquire the speed information of the host vehicle from, for example, the speed sensor, the vehicle meter, or the car navigation system of the host vehicle, or may measure the speed information by the communication apparatus 400.

The captured image acquisition unit 430 acquires the captured image obtained when the image capturing unit 310 images the position related to the advertisement. The captured image acquisition unit 430 may acquire the captured image from the storage unit 402.

The image information generation unit 432 generates image information including at least one of the captured image obtained by imaging the position related to the advertisement and image-related information related to the captured image. The image information generation unit 432 may store the generated image information in the storage unit 402.

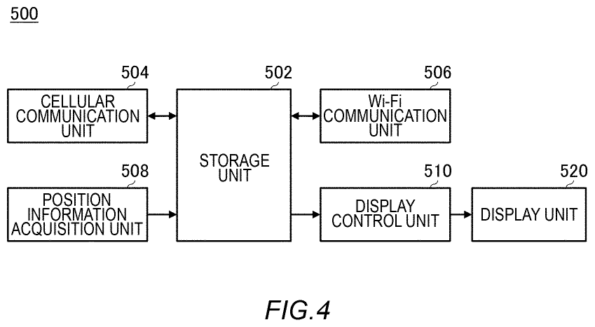

FIG. 4 schematically illustrates an example of the functional configuration of the communication terminal 500. The communication terminal 500 includes a storage unit 502, a cellular communication unit 504, a Wi-Fi communication unit 506, a position information acquisition unit 508, and a display control unit 510.

The storage unit 502 stores various types of information. The storage unit 402 stores, for example, the distribution information. The storage unit 402 may be an example of a terminal storage unit.

The cellular communication unit 504 wirelessly communicates with the wireless base station 30 by the cellular communication system. The cellular communication unit 504 accesses the network 20 via the wireless base station 30. The Wi-Fi communication unit 506 wirelessly communicates with the communication apparatus 400 by the Wi-Fi communication system.

The position information acquisition unit 508 acquires position information regarding the current position of the communication terminal 500. The position information acquisition unit 508 may acquire a positioning result by the positioning function of the communication terminal 500.

The display control unit 510 causes the information stored in the storage unit 502 to be displayed on the display unit 520 of the communication terminal 500. The display control unit 510 may cause the display unit 520 to display the advertisement content included in the distribution information stored in the storage unit 502. The display control unit 510 may cause the display unit 520 to display the distribution information stored in the storage unit 502.

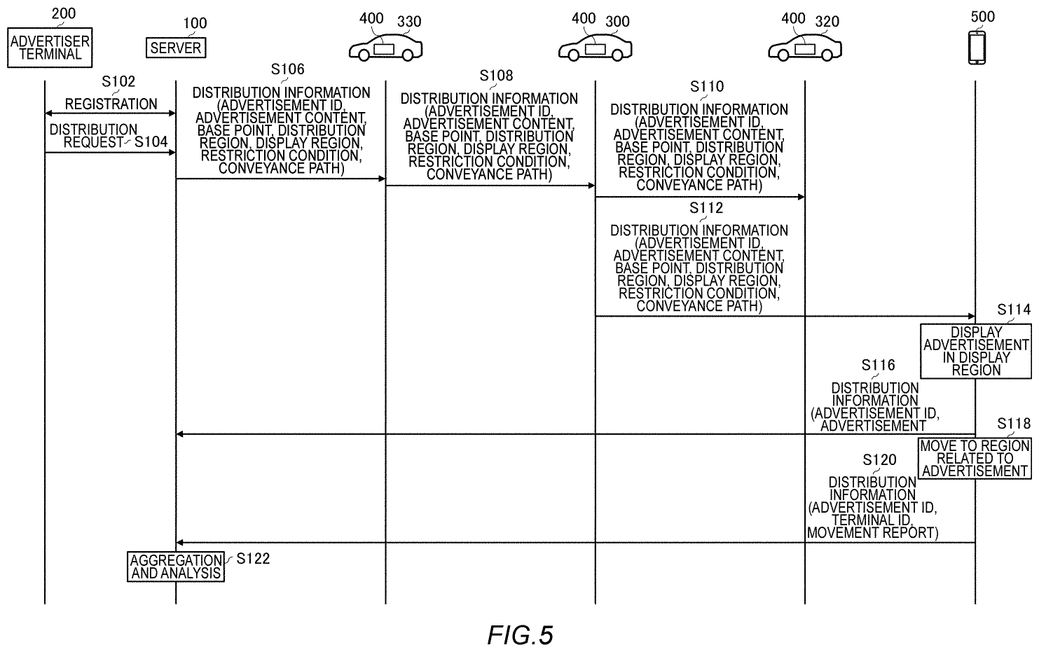

FIG. 5 schematically illustrates an example of a processing flow in the system 10. In FIG. 5, the conveyance processing of the distribution information will be mainly described.

The communication by the vehicle 300 is executed by the communication apparatus 400 of the vehicle 300. The vehicle 300 may be an example of a first moving object. The communication by the vehicle 320 is executed by the communication apparatus 400 of the vehicle 320. The vehicle 320 may be an example of a second moving object. The communication by the vehicle 330 is executed by the communication apparatus 400 of the vehicle 330. The vehicle 330 may be an example of a third moving object.

In Step 102 (a step may be abbreviated as S), the advertiser terminal 200 registers various types of information in the server 100. The advertiser terminal 200 may register various types of information in the server 100 according to the instruction of the advertiser.

The advertiser terminal 200 registers the advertisement content. The advertiser terminal 200 may register base point information which is the information of the advertisement base point 202. The advertiser terminal 200 may register distribution region information indicating a geographic region (which may be described as a distribution region) to which the advertisement is distributed. The advertiser terminal 200 may register display region information indicating a geographic region (which may be described as a display region) in which the advertisement is displayed on the display unit 520 of the communication terminal 500. The advertiser terminal 200 may register a restriction condition for restricting the transmission of the advertisement and the transfer to another device.

For each advertisement, the server 100 may generate the distribution information including advertisement identification information (which may be described as an advertisement ID) for identifying the advertisement and various types of information registered by the advertiser terminal 200. The advertisement ID is, for example, a unique number unique to each advertisement.

In S104, the advertiser terminal 200 transmits the distribution request of the distribution information to the server 100. For example, the advertiser terminal 200 transmits, to the server 100, the distribution request with the advertisement ID designated.

In S106, the server 100 transmits the distribution information to the vehicle 330 specified as a target for transmitting the distribution information via the network 20 and the wireless base station 30. Furthermore, in S106, the distribution information may be transmitted not from the server 100 but from the advertiser terminal 200 to the vehicle 330. In this case, the vehicle 330 and the advertiser terminal 200 may perform direct communication or indirect communication via the wireless base station 30. The cellular communication unit 404 of the vehicle 330 receives the distribution information transmitted by the server 100 or the advertiser terminal 200.

In the example illustrated in FIG. 5, the distribution information includes the advertisement ID, the advertisement content, the base point information, the distribution region information, the display region information, the restriction condition, and conveyance path information. The conveyance path information is information for indicating a path through which the distribution information has been conveyed. In the conveyance path information, for example, the moving object identification information of the vehicle 300 which conveys the distribution information is registered. The moving object identification information may be any information that can identify the vehicle 300.

The communication apparatus 400 of the vehicle 330 may execute the conveyance of the distribution information when it is determined with reference to the distribution region information included in the received distribution information that the current position of the vehicle 330 is included in the distribution region. Here, the description will be continued on the assumption that it is determined to be included.

In S108, the vehicle 330 adds the moving object identification information of the vehicle 330 to the conveyance path information included in the distribution information, and transmits the distribution information to the vehicle 300 via the vehicle-to-vehicle communication. The vehicle-to-vehicle communication unit 414 of the vehicle 300 receives the distribution information transmitted by the vehicle 330 and stores the distribution information in the storage unit 402. The distribution information management unit 416 may add the moving object identification information of the vehicle 300 to the conveyance path information of the received distribution information.

The distribution information management unit 416 of the vehicle 300 may manage the history of the advertisement identification information of the received distribution information, and may delete the distribution information when the vehicle-to-vehicle communication unit 414 receives the distribution information, and the advertisement identification information of the distribution information is included in the history. Note that the distribution information management unit 416 of the vehicle 330 may notify the vehicle 300 of the advertisement identification information of the received distribution information, and transmit the distribution information to the vehicle 300 upon response from the vehicle 300.

The control unit of the communication apparatus 400 of the vehicle 300 determines whether the position indicated by the position information acquired by the position information acquisition unit 420 is included in the distribution region indicated by the distribution region information included in the distribution information. When it is determined that the position is included, the vehicle-to-vehicle communication unit 414 determines that the distribution information can be transmitted to another vehicle. Furthermore, when it is determined that the position is included, the communication relay unit 408 determines that the distribution information can be transmitted to the communication terminal 500 for which communication is relayed.

In S110, the vehicle-to-vehicle communication unit 414 of the vehicle 300 transmits the distribution information to the vehicle 320 via the vehicle-to-vehicle communication. In S112, the communication relay unit 408 of the vehicle 300 transmits the distribution information via the terminal communication unit 406 to the communication terminal 500 for which communication is relayed.

The Wi-Fi communication unit 506 of the communication terminal 500 stores the received distribution information in the storage unit 502. The display control unit 510 of the communication terminal 500 determines whether the communication terminal 500 is positioned in the display region indicated by the display region information included in the distribution information. The display control unit 510 may determine whether the position indicated by the position information acquired by the position information acquisition unit 508 is included in the display region.

In S114, the display control unit 510 causes the advertisement to be displayed on the display unit 520 in response to the determination that the communication terminal 500 is positioned in the display region. The display control unit 510 may cause the display unit 520 to display the advertisement content included in the distribution information. The display control unit 510 does not cause the display unit 520 to display the advertisement included in the distribution information while the communication terminal 500 is not positioned in the display region.

In S116, in response to causing the display unit 520 to display the advertisement, the cellular communication unit 504 transmits report information to the server 100. The cellular communication unit 504 may transmit the report information to the server 100 via the wireless base station 30 and the network 20. The report information may include the advertisement ID, information on a location and time to display the advertisement, the conveyance path information, and terminal identification information (which may be described as a terminal ID) for identifying the communication terminal 500. The information on the location where the advertisement is displayed may be the position information acquired by the position information acquisition unit 508 when the display unit 520 displays the advertisement.

In S118, the control unit of the communication terminal 500 determines whether the communication terminal 500 moves to the position related to the advertisement. For example, when the communication terminal 500 is positioned in the geographic region indicated by the advertisement base point 202 of the base point information included in the distribution information, the control unit of the communication terminal 500 determines that the communication terminal 500 moves to the position related to the advertisement. Here, the description will be continued assuming that it is determined that the communication terminal moves to the position.

In S120, in response to the determination that the communication terminal 500 moves to the position related to the advertisement, the cellular communication unit 504 transmits the report information to the server 100. The cellular communication unit 504 may transmit the report information to the server 100 via the wireless base station 30 and the network 20. The report information may include the advertisement ID, the terminal ID of the communication terminal 500, and a movement report indicating that the communication terminal 500 moves to the position related to the advertisement.

In S122, the server 100 executes aggregation, analysis, and the like of the received report information. By the aggregation and analysis, it is possible to specify how the distribution information is conveyed, the vehicle which contributes to the conveyance of the distribution information, the number of times the distribution information is displayed, the number of people browsing the distribution information, the number of people moving to the position related to the advertisement due to the distribution information, and the like. Note that, in FIG. 5, a case where it is reported to the server 100 that the communication terminal 500 moves to the position related to the advertisement has been described as an example, but the present invention is not limited thereto. When the Wi-Fi hotspot is disposed at the position related to the advertisement, the Wi-Fi hotspot may notify the server 100 that the communication terminal 500 is connected to the Wi-Fi hotspot.

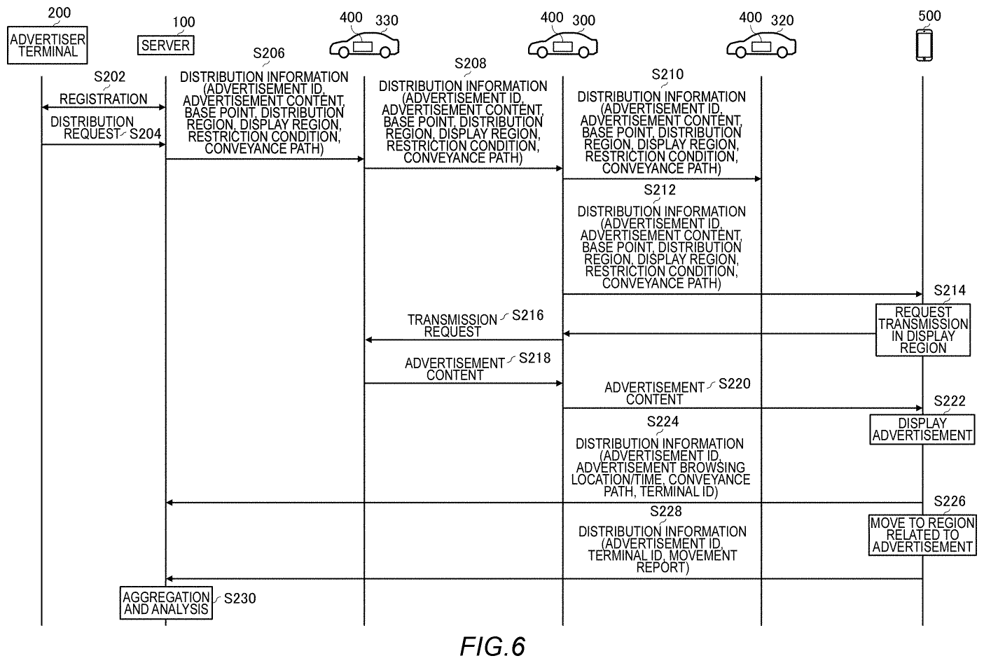

FIG. 6 schematically illustrates an example of the processing flow in the system 10. In FIG. 6, the conveyance processing of the distribution information will be mainly described. Here, a difference from FIG. 5 will be mainly described.

In S202, the advertiser terminal 200 registers various types of information in the server 100 according to the instruction of the advertiser. In S204, the advertiser terminal 200 transmits the distribution request of the distribution information to the server 100.

In S206, the server 100 transmits the distribution information to the vehicle 330 specified as the target for transmitting the distribution information via the network 20 and the wireless base station 30. In the example illustrated in FIG. 6, the distribution information includes the advertisement ID, the advertisement content, the base point information, the distribution region information, the display region information, the restriction condition, and the conveyance path information. The cellular communication unit 404 of the vehicle 330 receives the distribution information transmitted by the server 100.

In S208, the vehicle 330 saves the advertisement content included in the distribution information in the storage unit 402 of the vehicle 330, and replaces the advertisement content included in the distribution information with saving position information indicating a position where the advertisement content is saved. The saving position information may be information which allows the position where the advertisement content is saved to be specified from the outside. For example, the saving position information includes the moving object identification information of the vehicle 330 and a saving spot in the storage unit 402 of the vehicle 330. Then, the vehicle 330 transmits the distribution information to the vehicle 300 via the vehicle-to-vehicle communication.

The vehicle-to-vehicle communication unit 414 of the vehicle 300 receives the distribution information transmitted by the vehicle 330 and stores the distribution information in the storage unit 402. The distribution information management unit 416 may add the moving object identification information of the vehicle 300 to the conveyance path information of the distribution information. The control unit of the communication apparatus 400 of the vehicle 300 determines whether the position indicated by the position information acquired by the position information acquisition unit 420 is included in the distribution region indicated by the distribution region information included in the distribution information. When it is determined that the position is included, the vehicle-to-vehicle communication unit 414 determines that the distribution information can be transmitted to another vehicle. Furthermore, when it is determined that the position is included, the communication relay unit 408 determines that the distribution information can be transmitted to the communication terminal 500 for which communication is relayed.

In S210, the vehicle-to-vehicle communication unit 414 of the vehicle 300 transmits the distribution information to the vehicle 320 via the vehicle-to-vehicle communication. In S212, the communication relay unit 408 of the vehicle 300 transmits the distribution information via the terminal communication unit 406 to the communication terminal 500 for which communication is relayed. Note that a case where the communication terminal 500 receives the distribution information from the communication relay unit 408 of the vehicle 300 will be described here, but the communication terminal 500 may receive the distribution information from the communication relay unit 408 of the vehicle 320.

The Wi-Fi communication unit 506 of the communication terminal 500 stores the received distribution information in the storage unit 502. The control unit of the communication terminal 500 determines whether the communication terminal 500 is positioned in the display region indicated by the display region information included in the distribution information. The display control unit 510 may determine whether the position indicated by the position information acquired by the position information acquisition unit 508 is included in the display region.

In S214, the Wi-Fi communication unit 506 transmits the transmission request of the advertisement content to the vehicle 300 in response to the determination that the communication terminal 500 is positioned in the display region. The communication relay unit 408 of the vehicle 300 receives the transmission request of the advertisement content, and stores the transmission request in storage unit 402.

Note that, here, an example in which the transmission request of the advertisement content is transmitted to the vehicle 300 will be described, but the present invention is not limited thereto. When the communication terminal 500 establishes the wireless communication connection with a vehicle other than the vehicle 300 at the timing of transmitting the transmission request of the advertisement content, the Wi-Fi communication unit 506 may transmit the transmission request of the advertisement content to the vehicle. Furthermore, the cellular communication unit 504 may transmit the transmission request of the advertisement content to the vehicle 330 saving the advertisement content via the wireless base station 30 and the network 20.

In S216, the vehicle-to-vehicle communication unit 414 of the vehicle 300 transmits the transmission request of the advertisement content to the vehicle 330. The vehicle-to-vehicle communication unit 414 of the vehicle 300 may transmit the transmission request of the advertisement content to the vehicle 330 via another vehicle. For example, the vehicle-to-vehicle communication unit 414 of the vehicle 300 directly transmits the transmission request of the advertisement content to the vehicle 330 when the vehicle 330 is positioned within a range of the vehicle-to-vehicle communication, and transmits the transmission request of the advertisement content to the vehicle 330 via a vehicle other than the vehicle 330 when the vehicle 330 is not positioned within the range of the vehicle-to-vehicle communication. In this way, the conveyance path of the transmission request of the advertisement content may or may not depend on the conveyance path of the distribution information. In S218, the vehicle-to-vehicle communication unit 414 of the vehicle 330 transmits the advertisement content stored in the storage unit 402 to the vehicle 300 in response to the transmission request of the advertisement content received in S216. The vehicle-to-vehicle communication unit 414 of the vehicle 330 may transmit the advertisement content to the vehicle 300 via another vehicle. For example, the vehicle-to-vehicle communication unit 414 of the vehicle 330 directly transmits the advertisement content to the vehicle 300 when the vehicle 300 is positioned within the range of the vehicle-to-vehicle communication, and transmits the advertisement content to the vehicle 300 via a vehicle other than the vehicle 300 when the vehicle 300 is not positioned within the range of the vehicle-to-vehicle communication. In this way, the conveyance path of the advertisement content may or may not depend on the conveyance path of the distribution information and the conveyance path of the transmission request of the advertisement content. The vehicle-to-vehicle communication unit 414 of the vehicle 300 stores the received advertisement content in the storage unit 402. In S220, the communication relay unit 408 of the vehicle 300 transmits the advertisement content stored in the storage unit 402 in S218 to the communication terminal 500 as a response to the transmission request of the advertisement content received from the communication terminal 500 in S214. The Wi-Fi communication unit 506 of the communication terminal 500 stores the received advertisement content in the storage unit 502. In S222, the display control unit 510 of the communication terminal 500 causes the advertisement content received in S220 to be displayed on the display unit 520.

In S224, in response to causing the display unit 520 to display the advertisement content, the cellular communication unit 504 transmits the report information to the server 100. In S226, the control unit of the communication terminal 500 determines whether the communication terminal 500 moves to the position related to the advertisement. In S228, in response to the determination that the communication terminal 500 moves to the position related to the advertisement, the cellular communication unit 504 transmits the report information to the server 100. In S230, the server 100 executes the aggregation, analysis, and the like of the received report information.

As illustrated in FIG. 6, by conveying the saving position information indicating the saving position of the advertisement content instead of the advertisement content, it is possible to reduce the communication amount at the time of conveying the distribution information. Therefore, the distribution information can be conveyed with high reliability even in communication having a restriction on a communication time, for example, the vehicle-to-vehicle communication.

In S206, the server 100 may specify a vehicle which is less likely to move as the target for transmitting the distribution information including the advertisement content. For example, the server 100 specifies a parked vehicle as the target for transmitting the distribution information. Furthermore, for example, the server 100 specifies a stopped vehicle as the target for transmitting the distribution information. Accordingly, it is possible to reduce a possibility that the vehicle saving the advertisement content moves out of the distribution region and the acquisition destination of the advertisement content is not present in the distribution region.

In S206, the server 100 may specify a vehicle having a slower moving speed as the target for transmitting the distribution information including the advertisement content. For example, the server 100 periodically collects the moving speeds of a plurality of vehicles, and specifies a vehicle having a slower moving speed among the plurality of vehicles.

In FIG. 6, a case where the server 100 transmits the distribution information including the advertisement content to the vehicle 330 is exemplified in S206, but the present invention is not limited thereto. The server 100 may save the advertisement content by itself without conveying the advertisement content to the vehicle. For example, in S206, the server 100 transmits not the advertisement content but the distribution information including the saving position information to the vehicle 330. In this case, instead of conveying the transmission request of the advertisement content by the vehicle-to-vehicle communication, the communication terminal 500 may transmit the transmission request to the server 100 via the wireless base station 30 and the network 20 by the cellular communication.

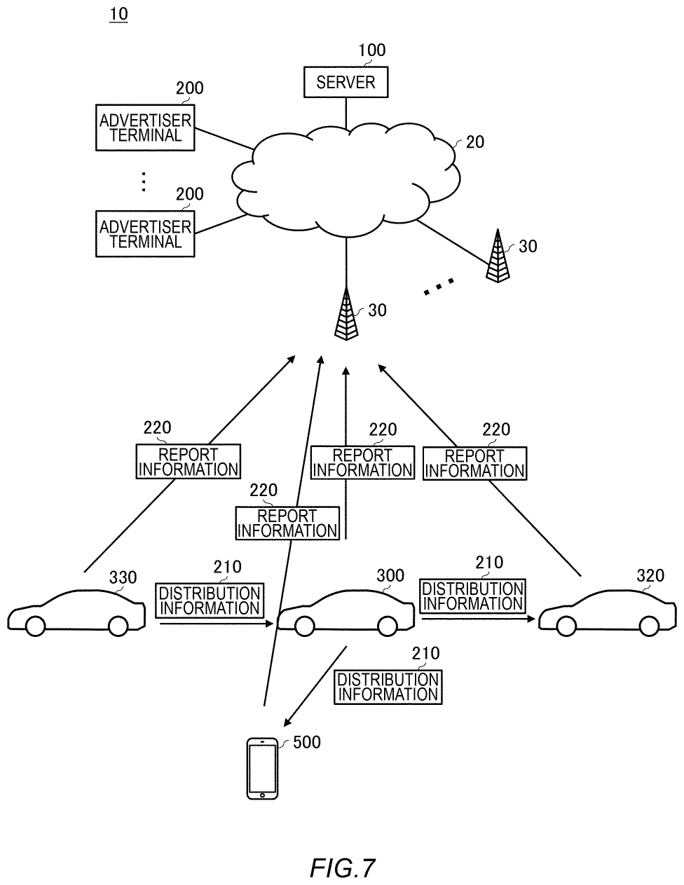

FIG. 7 schematically illustrates a report processing flow in the system 10. In the example illustrated in FIG. 7, the communication apparatus 400 and the communication terminal 500 transmit the report information 220 to the server 100 by using the cellular communication. In the example illustrated in FIG. 7, the vehicle 330 receives the distribution information 210 from the server 100, the advertiser terminal 200, or another vehicle and conveys the distribution information to the vehicle 300, and the vehicle 300 conveys the distribution information to each of the vehicle 320 and the communication terminal 500.

For example, the cellular communication unit 404 of the vehicle 330 transmits the report information 220 for reporting the reception of the distribution information 210 to the server 100 via the wireless base station 30 and the network 20. The cellular communication unit 404 of the vehicle 330 may transmit the report information 220 including the advertisement ID included in the distribution information 210 and the moving object identification information of the vehicle 330 to the server 100.

For example, the cellular communication unit 404 of the vehicle 300 transmits the report information 220, which reports that the vehicle-to-vehicle communication unit 414 receives the distribution information 210 from the vehicle 330, to the server 100 via the wireless base station 30 and the network 20. The cellular communication unit 404 may transmit the report information 220 including the advertisement ID included in the distribution information 210 and the moving object identification information of the vehicle 300 to the server 100.

The cellular communication unit 404 may include, in the report information 220, the moving object identification information of the vehicle 330 as the transmission source of the distribution information 210 received by the vehicle-to-vehicle communication unit 414. Furthermore, when the vehicle-to-vehicle communication unit 414 transmits the distribution information 210 to the vehicle 320, the cellular communication unit 404 may include, in the report information 220, the moving object identification information of the vehicle 320 as the transmission destination of the distribution information 210.

The cellular communication unit 404 may include, in the report information 220, the position information of the vehicle 300, which is acquired by the position information acquisition unit 420, at the time of the vehicle-to-vehicle communication unit 414 receiving the distribution information 210. The cellular communication unit 404 may include, in the report information 220, the position information of the vehicle 320, which is acquired by the position information acquisition unit 420, at the time of the vehicle-to-vehicle communication unit 414 transmitting the distribution information 210 to the vehicle 300. The cellular communication unit 404 may include time information regarding the time when the vehicle-to-vehicle communication unit 414 received the distribution information 210 in the report information 220.

The cellular communication unit 404 of the vehicle 330 may transmit the report information 220, which reports the transmission of the distribution information 210 to the vehicle 300, to the server 100 via the wireless base station 30 and the network 20. The cellular communication unit 404 of the vehicle 300 may transmit the report information 220, which reports that the vehicle-to-vehicle communication unit 414 transmits the distribution information 210 to the vehicle 320, to the server 100 via the wireless base station 30 and the network 20.

The cellular communication unit 504 of the communication terminal 500 may transmit the report information 220, which reports that the Wi-Fi communication unit 506 receives the distribution information 210 from the vehicle 300, to the server 100 via the wireless base station 30 and the network 20. The cellular communication unit 504 may transmit the report information 220 including the advertisement ID included in the distribution information 210 and the terminal identification information of the communication terminal 500 to the server 100. Furthermore, the communication terminal 500 may transmit the report information 220 to the wireless base station 30 via the vehicle 300 by using the Wi-Fi communication unit 506.

After the advertisement content included in the received distribution information is displayed on the display unit 520, when the communication terminal 500 is positioned in the geographic region indicated by the advertisement-related position information included in the distribution information 210, the cellular communication unit 504 may transmit, to the server 100, the report information 220 including the advertisement ID, the terminal identification information of the communication terminal 500, and the information indicating that the communication terminal 500 moves to the advertisement-related position.

As illustrated in FIG. 7, when the vehicle 300 and the communication terminal 500 are configured to transmit the report information 220 to the server 100 by using the cellular communication, it is possible to achieve reliable and highly real-time aggregation and analysis although there is a possibility that a cellular communication cost is incurred.

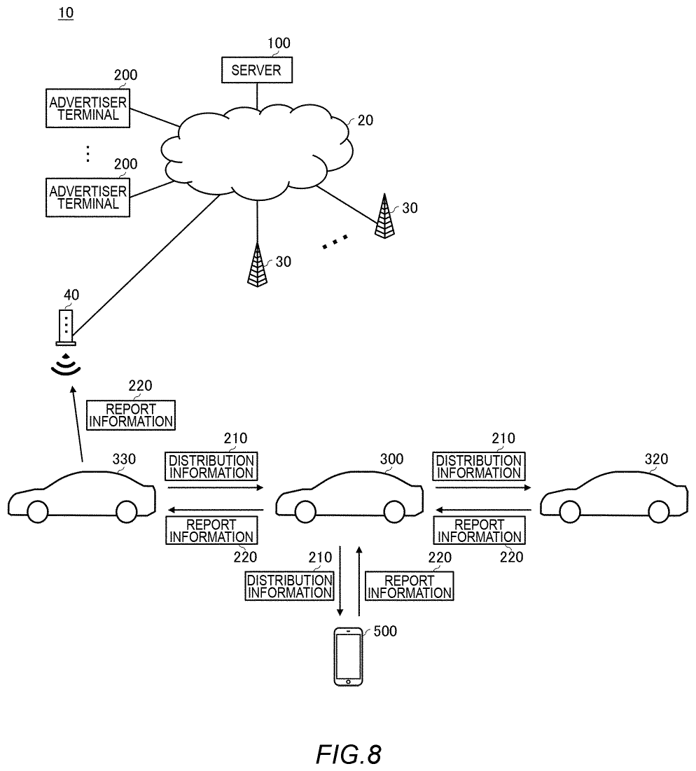

FIG. 8 schematically illustrates a report processing flow in the system 10. Here, a difference from FIG. 7 will be mainly described. In FIG. 8, a case will be described in which the report information 220 is conveyed between the vehicles, and the vehicle in which a low cost communication system having a lower communication cost than the cellular communication system becomes available collectively transmit the report information 220 to the server 100 by using the low cost communication system. In the example illustrated in FIG. 8, the Wi-Fi communication system via an access point 40 is exemplified as the low cost communication system. The access point 40 is, for example, a so-called free Wi-Fi hotspot or a roadside unit.

In the example illustrated in FIG. 8, the distribution information 210 is conveyed from the vehicle 330 to the vehicle 300, and is conveyed from the vehicle 300 to each of the vehicle 320 and the communication terminal 500. Then, he vehicle 320 transmits, to the vehicle 300, the report information 220 for reporting the reception of the distribution information 210 from the vehicle 300, and the communication terminal 500 transmits, to the vehicle 300, the report information 220 for reporting the reception of the distribution information 210 from the vehicle 300. The communication terminal 500 may transmit, to the vehicle 300, the report information 220 for reporting that the communication terminal 500 moves to the position related to the advertisement.

The vehicle-to-vehicle communication unit 414 of the vehicle 300 stores the report information 220 received from the vehicle 320 in the storage unit 402. Furthermore, the communication relay unit 408 of the vehicle 300 stores the report information 220 received from the communication terminal 500 in the storage unit 402. Then, the vehicle-to-vehicle communication unit 414 of the vehicle 300 transmits, to the vehicle 330, the report information 220 for reporting the reception of the distribution information 210 from the vehicle 330, and the report information 220 received from the vehicle 330 and the report information 220 received from the communication terminal 500, which are stored in the storage unit 402. The vehicle-to-vehicle communication unit 414 may be an example of a stored information transmission unit.

The vehicle-to-vehicle communication unit 414 of the vehicle 330 stores the report information 220 received from the vehicle 300 in the storage unit 402. In response to the establishment of the wireless communication connection with the access point 40, the AP communication unit 412 of the vehicle 330 transmits the report information 220 stored in the storage unit 402 to the server 100 via the access point 40 and the network 20, and deletes the report information 220 from the storage unit 402.

When the AP communication unit 412 of the vehicle 300 establishes the wireless communication connection with the access point 40, the AP communication unit 412 of the vehicle 300 may transmit the report information 220 stored in the storage unit 402 to the server 100 via the access point 40 and the network 20 in response to the establishment of the wireless communication connection with the access point 40, and may delete the report information 220 from the storage unit 402. The AP communication unit 412 may be an example of the stored information transmission unit.

As illustrated in FIG. 8, with a configuration in which the report information 220 is conveyed between the vehicles, and the vehicle in which the low cost communication system becomes available collectively transmit the report information 220 to the server 100, it is possible to reduce the communication cost as compared with a case where the vehicle 300 and the communication terminal 500 transmit the report information 220 to the server 100 by using the cellular communication system.

In the example illustrated in FIG. 8, the report information 220 may include a stop condition for stopping the conveyance of the report information 220. The stop condition indicates, for example, a stop time. In this case, when the stop time indicated by the stop condition of the report information 220 has elapsed, the vehicle which receives the report information 220 may delete the report information 220 without conveying the report information 220 to another vehicle.

The stop condition may indicate a stop HOP count. In this case, the HOP count of conveyance may be recorded in the report information 220. When the HOP count recorded in the report information 220 is equal to the HOP count of conveyance indicated by the stop condition of the report information 220, the vehicle which receives the report information 220 may delete the report information 220 without conveying the report information 220 to another vehicle. Accordingly, it is possible to prevent an increase in communication traffic in the vehicle network.

Note that, in FIG. 8, a case where the report information 220 is conveyed in the same conveyance path as the conveyance path of the distribution information 210 has been described as an example, but the present invention is not limited thereto. The conveyance path of the report information 220 may be different from the conveyance path of the distribution information 210.

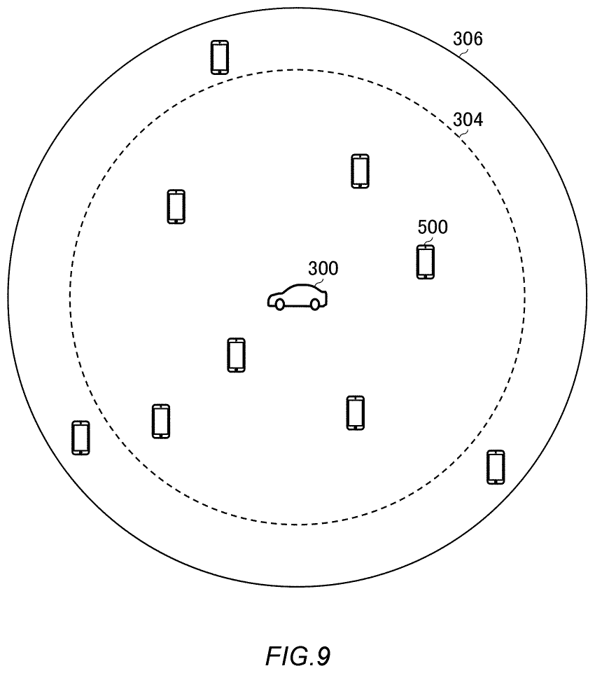

FIG. 9 is an explanatory diagram for explaining control processing of communication setting by the communication control unit 410. FIG. 9 illustrates a case where the communication control unit 410 controls the size of the wireless communication area in which the terminal communication unit 406 performs the wireless communication with the communication terminal 500.

The communication control unit 410 may control the size of the wireless communication area based on the advertisement-related position information included in the distribution information stored in the storage unit 402 of the vehicle 300 and indicating the position related to the advertisement and the moving object position information acquired by the position information acquisition unit 420 and regarding the current position of the vehicle 300.

For example, when a state where the position indicated by the moving object position information does not correspond to the position indicated by the advertisement-related position information is changed into a state where the positions correspond, the communication control unit 410 controls the communication setting. In FIG. 9, a wireless communication area 304 indicates a wireless communication area in a state where the position indicated by the moving object position information does not correspond to the position indicated by the advertisement-related position information, and a wireless communication area 306 indicates a wireless communication area in a state where the positions correspond. In this way, the communication control unit 410 may control the communication setting such that the size of the wireless communication area when the position indicated by the moving object position information corresponds to the position indicated by the advertisement-related position information is large as compared with a case where the positions do not correspond.

When the advertisement-related position information indicates the position of the transmission source of the advertisement, the communication control unit 410 may control the communication setting when a state where a distance between the position indicated by the moving object position information and the position of the transmission source of the advertisement is longer than a predetermined threshold value is changed into a state where the distance is shorter than the threshold value. In FIG. 9, the wireless communication area 304 indicates a wireless communication area in a state where the distance between the position indicated by the moving object position information and the position of the transmission source of the advertisement is longer than the predetermined threshold value, and the wireless communication area 306 indicates a wireless communication area in a state where the distance is shorter than the threshold value. In this way, the communication control unit 410 may control the communication setting such that the size of the wireless communication area when the distance between the position indicated by the moving object position information and the position of the transmission source of the advertisement is shorter than the predetermined threshold value is large as compared with a case where the distance is longer than the predetermined threshold value.

When the advertisement-related position information indicates the geographic region related to the advertisement, the communication control unit 410 may control the communication setting when a state where the position indicated by the moving object position information is not included in the geographic region related to the advertisement is changed into a state where the position is included therein. The advertisement-related position information may indicate the distribution region to which the advertisement is distributed. Furthermore, the advertisement-related position information may indicate the display region in which the advertisement is displayed. In FIG. 9, the wireless communication area 304 indicates a wireless communication area in a state where the position indicated by the moving object position information is not included in the geographic region related to the advertisement, and the wireless communication area 306 indicates a wireless communication area in a state where the position is included. In this way, the communication control unit 410 may control the communication setting such that the size of the wireless communication area when the position indicated by the moving object position information is included in the related geographic region is large as compared with a case where the position is not included therein.

As a result, when the vehicle 300 is positioned near the transmission source of the advertisement, the distribution information can be transmitted to more communication terminals 500 by relatively increasing the size of the wireless communication area. Furthermore, when the vehicle 300 is not positioned near the transmission source of the advertisement, the power consumption of the vehicle 300 can be reduced by relatively reducing the size of the wireless communication area.

The fact that the vehicle 300 is positioned near the transmission source of the advertisement means that the communication terminal 500 establishing the wireless communication connection with the vehicle 300 is also positioned relatively near the transmission source of the advertisement. Therefore, by transmitting the distribution information to the communication terminal 500, a possibility that the owner of the communication terminal 500 moves to the transmission source of the advertisement is high as compared with a case where the vehicle 300 is not positioned near the transmission source of the advertisement. Thus, by relatively increasing the size of the wireless communication area when the vehicle 300 is positioned near the transmission source of the advertisement, the number of distributions of the advertisement can be increased when an advertising effect is larger, and the power consumption can be reduced when the advertising effect is smaller.

The communication control unit 410 may control the communication setting for communication with the communication terminal 500 based on the speed information of the vehicle 300 acquired by the speed information acquisition unit 422. For example, the communication control unit 410 controls the communication setting such that the size of the wireless communication area in which the wireless communication with the communication terminal 500 is performed is reduced when the moving speed of the vehicle 300 increases. Accordingly, when the moving speed of the vehicle 300 is relatively high and the wireless communication with the communication terminal 500 cannot be stably performed, the number of communication terminals 500 as the targets for transmitting the distribution information can be reduced.

The communication control unit 410 may control the communication setting such that the size of the wireless communication area in which the wireless communication with the communication terminal 500 is performed is increased when the moving speed of the vehicle 300 increases. Accordingly, when the moving speed of the vehicle 300 is relatively high, a time until the communication terminal 500 leaves the wireless communication area can be lengthened, and a possibility that the distribution information can be transmitted to the communication terminal 500 can be improved.

The communication control unit 410 may control the communication setting for communication with the communication terminal 500 based on the number of pieces of distribution information stored in the storage unit 402. For example, the communication control unit 410 controls the communication setting such that the size of the wireless communication area in which the terminal communication unit 406 performs the wireless communication with the communication terminal 500 is increased when the number of pieces of distribution information stored in the storage unit 402 increases.

In FIG. 9, a case where the communication control unit 410 controls the size of the wireless communication area in which the terminal communication unit 406 performs the wireless communication with the communication terminal 500 has been described, but the present invention is not limited thereto. The communication control unit 410 may control, as the communication setting, the allowable number of connections for the communication relay unit 408 to establish the wireless communication connection with the communication terminal 500.

The communication control unit 410 may change the allowable number of connections based on the advertisement-related position information included in the distribution information stored in the storage unit 402 of the vehicle 300 and indicating the position related to the advertisement and the moving object position information acquired by the position information acquisition unit 420 and regarding the current position of the vehicle 300. For example, when a state where the position indicated by the moving object position information does not correspond to the position indicated by the advertisement-related position information is changed into a state where the positions correspond, the communication control unit 410 changes the allowable number of connections.

When the advertisement-related position information indicates the position of the transmission source of the advertisement, the communication control unit 410 may change the allowable number of connections when a state where the distance between the position indicated by the moving object position information and the position of the transmission source of the advertisement is longer than the predetermined threshold value is changed into a state where the distance is shorter than the threshold value. For example, the communication control unit 410 increases the allowable number of connections when the distance between the position indicated by the moving object position information and the position of the transmission source of the advertisement is shorter than the predetermined threshold value as compared with a case where the distance is longer than the predetermined threshold value.

When the advertisement-related position information indicates the geographic region related to the advertisement, the communication control unit 410 may change the allowable number of connections when a state where the position indicated by the moving object position information is not included in the geographic region related to the advertisement is changed into a state where the position is included therein. For example, the communication control unit 410 increases the allowable number of connections when the position indicated by the moving object position information is included in the related geographic region as compared with a case where the position is not included therein.

As a result, when the vehicle 300 is positioned near the transmission source of the advertisement, the distribution information can be transmitted to more communication terminals 500 by relatively increasing the allowable number of connections. Furthermore, when the vehicle 300 is not positioned near the transmission source of the advertisement, the power consumption of the vehicle 300 can be reduced by relatively reducing the allowable number of connections.

The communication control unit 410 may control, as the communication setting, the allowable connection time for the communication relay unit 408 to establish the wireless communication connection with the communication terminal 500. The communication control unit 410 may change the allowable connection time based on the advertisement-related position information included in the distribution information stored in the storage unit 402 of the vehicle 300 and indicating the position related to the advertisement and the moving object position information acquired by the position information acquisition unit 420 and regarding the current position of the vehicle 300. For example, when a state where the position indicated by the moving object position information does not correspond to the position indicated by the advertisement-related position information is changed into a state where the positions correspond, the communication control unit 410 changes the allowable connection time.

When the advertisement-related position information indicates the position of the transmission source of the advertisement, the communication control unit 410 may change the allowable connection time when a state where the distance between the position indicated by the moving object position information and the position of the transmission source of the advertisement is longer than the predetermined threshold value is changed into a state where the distance is shorter than the threshold value. For example, the communication control unit 410 shortens the allowable connection time when the distance between the position indicated by the moving object position information and the position of the transmission source of the advertisement is shorter than the predetermined threshold value as compared with a case where the distance is longer than the predetermined threshold value.

When the advertisement-related position information indicates the geographic region related to the advertisement, the communication control unit 410 may change the allowable connection time when a state where the position indicated by the moving object position information is not included in the geographic region related to the advertisement is changed into a state where the position is included therein. For example, the communication control unit 410 shortens the allowable connection time when the position indicated by the moving object position information is included in the related geographic region as compared with a case where the position is not included therein.

As a result, when the vehicle 300 is positioned near the transmission source of the advertisement, the distribution information can be transmitted to more communication terminals 500 by relatively shortening the allowable connection time.

The communication control unit 410 may control, as the communication setting, on/off of the relay function of the communication relay unit 408. The communication control unit 410 may control on/off of the communication relay unit 408 based on the advertisement-related position information included in the distribution information stored in the storage unit 402 of the vehicle 300 and indicating the position related to the advertisement and the moving object position information acquired by the position information acquisition unit 420 and regarding the current position of the vehicle 300. For example, when a state where the position indicated by the moving object position information does not correspond to the position indicated by the advertisement-related position information is changed into a state where the positions correspond, the communication control unit 410 controls on/off of the relay function of the communication relay unit 408.

When the advertisement-related position information indicates the position of the transmission source of the advertisement, the communication control unit 410 turns off the relay function in a state where the distance between the position indicated by the moving object position information and the position of the transmission source of the advertisement is longer than the predetermined threshold, and turns on the relay function when the state is changed into a state where the distance is shorter than the predetermined threshold. When the advertisement-related position information indicates the geographic region related to the advertisement, the communication control unit 410 turns off the relay function in a state where the position indicated by the moving object position information is not included in the geographic region related to the advertisement, and turns on the relay function when the state is changed to a state where the position is included therein.

As a result, it is possible to turn on the relay function and execute the distribution of the distribution information only when the vehicle 300 is positioned near the transmission source of the advertisement.

The communication control unit 410 may control the communication setting for communication with another vehicle by the vehicle-to-vehicle communication unit 414. The communication control unit 410 controls the communication setting for communication with another vehicle by the vehicle-to-vehicle communication unit 414 based on, for example, the advertisement-related position information and the moving object position information.

When it is determined that the position indicated by the moving object position information corresponds to the position indicated by the advertisement-related position information, the communication control unit 410 may widen a communication range in which the vehicle-to-vehicle communication unit 414 performs wireless communication with another vehicle as compared with a case where it is determined that the positions do not correspond. For example, when the advertisement-related position information indicates the position of the transmission source of the advertisement, the communication control unit 410 widens the communication range in which the vehicle-to-vehicle communication unit 414 performs the wireless communication with another vehicle when the distance between the position indicated by the moving object position information and the position of the transmission source of the advertisement is shorter than the predetermined threshold value as compared with a case where the distance is longer than the predetermined threshold value. Furthermore, for example, when the advertisement-related position information indicates the geographic region related to the advertisement, the communication control unit 410 widens the communication range in which the vehicle-to-vehicle communication unit 414 performs the wireless communication with another vehicle when the position indicated by the moving object position information is included in the geographic region related to the advertisement as compared with a case where the position is not included. Accordingly, when the vehicle 300 is positioned near the transmission source of the advertisement, the communication range of the vehicle-to-vehicle communication of the vehicle 300 can be widened, and the distribution information can be conveyed to more other vehicles 300.

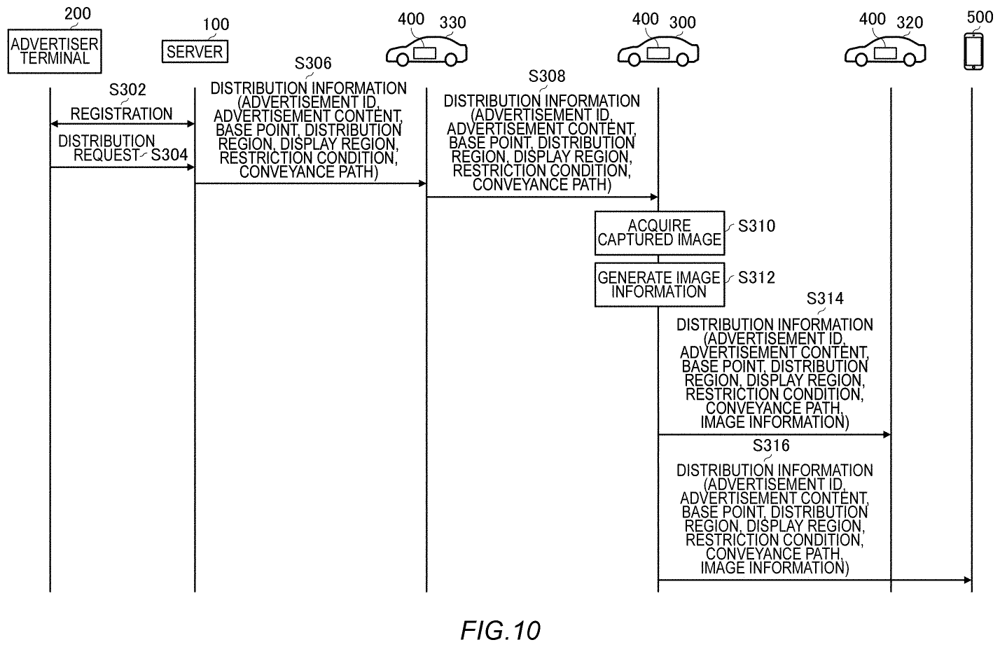

FIG. 10 schematically illustrates an example of the processing flow in the system 10. In FIG. 10, the conveyance processing of the distribution information will be mainly described. Here, a difference from FIG. 5 will be mainly described.

In S302, the advertiser terminal 200 registers various types of information in the server 100. In S304, the advertiser terminal 200 transmits the distribution request of the distribution information to the server 100.

In S306, the server 100 transmits the distribution information to the vehicle 330 specified as the target for transmitting the distribution information via the network 20 and the wireless base station 30. The cellular communication unit 404 of the vehicle 330 receives the distribution information transmitted by the server 100. In the example illustrated in FIG. 10, the distribution information includes the advertisement ID, the advertisement content, the base point information, the distribution region information, the display region information, the restriction condition, and the conveyance path information.

In S308, the vehicle 330 adds the moving object identification information of the vehicle 330 to the conveyance path information included in the distribution information, and transmits the distribution information to the vehicle 300 via the vehicle-to-vehicle communication. The vehicle-to-vehicle communication unit 414 of the vehicle 300 receives the distribution information transmitted by the vehicle 330 and stores the distribution information in the storage unit 402.

In S310, the captured image acquisition unit 430 acquires the captured image obtained when the image capturing unit 310 of the vehicle 300 images the position related to the advertisement indicated by the base point information included in the distribution information. In step S312, the image information generation unit 432 generates image information.

For example, the image information generation unit 432 generates the image information including the captured image acquired by the captured image acquisition unit 430 in S310. The image information generation unit 432 may generate the image information including the image-related information related to the captured image acquired by the captured image acquisition unit 430 in S310. The image-related information may include the saving position information indicating a position where the captured image is saved. The image-related information may include an analysis result obtained by analyzing the captured image. The image-related information may include situation information indicating the situation of the position related to the advertisement as the analysis result obtained by analyzing the image of the position related to the advertisement included in the captured image. For example, the image information generation unit 432 generates the situation information by analyzing the captured image. As a specific example, when the position related to the advertisement is a store, the image information generation unit 432 generates the situation information indicating the situation of the store by analyzing the portion of the store in the captured image. The situation information indicates, for example, a degree of congestion of the store, an amount of queue of the store, and the like. The image information generation unit 432 stores the generated image information in the storage unit 402.

In S314, the vehicle-to-vehicle communication unit 414 of the vehicle 300 transmits the distribution information, which is obtained when the distribution information management unit 416 adds the moving object identification information of the vehicle 300 to the conveyance path information, and the image information to the vehicle 320. For example, the vehicle-to-vehicle communication unit 414 may transmit the distribution information, which is edited by the distribution information management unit 416 to include the image information, to the vehicle 320. The vehicle-to-vehicle communication unit 414 may separately transmit the distribution information and the image information to the vehicle 320.

In S316, the communication relay unit 408 of the vehicle 300 transmits the distribution information, which is obtained when the distribution information management unit 416 adds the moving object identification information of the vehicle 300 to the conveyance path information, and the image information to the communication terminal 500. For example, the communication relay unit 408 may transmit the distribution information, which is edited by the distribution information management unit 416 to include the image information, to the communication terminal 500. The communication relay unit 408 may separately transmit the distribution information and the image information to the communication terminal 500.

As illustrated in FIG. 10, the image information including at least one of the captured image obtained by imaging the position related to the advertisement and the image-related information is conveyed together with the distribution information, so that the viewer of the distribution information can grasp the situation of the position related to the advertisement.

In FIG. 10, a case where the image information is conveyed by the vehicle-to-vehicle communication has been described, but the present invention is not limited thereto, and the image information may be transmitted to the server 100. For example, the vehicle 300 transmits the advertisement ID and the image information to the server 100 by using the cellular communication. The server 100 stores the image information in association with the advertisement ID. Then, the communication terminal 500 acquires the image information corresponding to the advertisement ID from the server 100 by transmitting the advertisement ID to the server 100, for example, by the cellular communication.

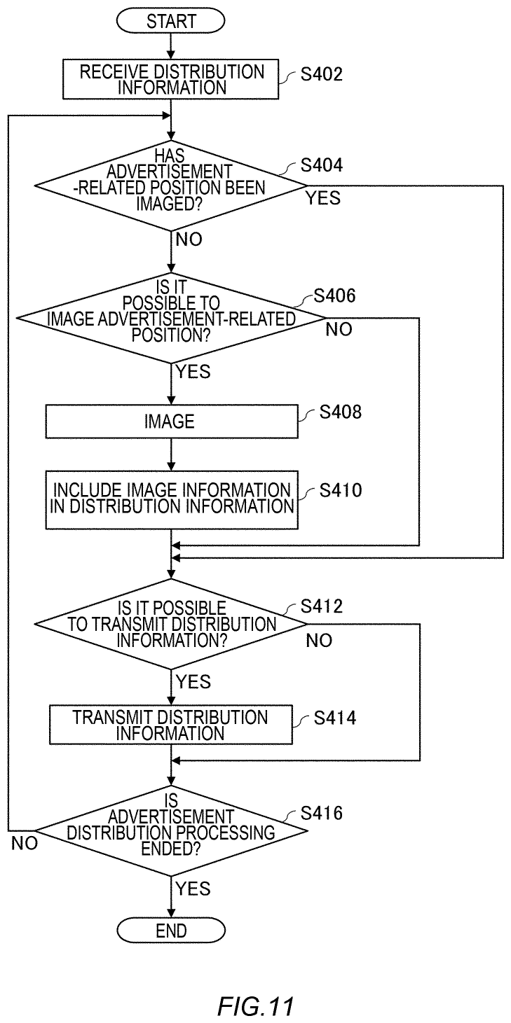

FIG. 11 illustrates an example of a flow of processing by the communication apparatus 400. In FIG. 11, a flow of transmitting the image information, which includes at least one of the captured image obtained by imaging the position related to the advertisement and the image-related information related to the captured image, and the distribution information to the outside will be described. Here, a case will be described in which the captured image acquisition unit 430 instructs the image capturing unit 310 to perform imaging based on the moving object position information of the vehicle 300 and the advertisement-related position information, and acquires the captured image captured by the image capturing unit 310.

In S402, the cellular communication unit 404 or the vehicle-to-vehicle communication unit 414 receives the distribution information. When the advertisement-related position indicated by the base point information included in the distribution information has not been imaged (NO in S404), the procedure proceeds to S406, and when the advertisement-related position has been imaged (YES in S404), the procedure proceeds to S412.

In S406, the captured image acquisition unit 430 determines whether the advertisement-related position can be imaged by the image capturing unit 310. The captured image acquisition unit 430 may determine whether the advertisement-related position can be imaged according to the position indicated by the moving object position information and the position indicated by the advertisement-related position information. When it is determined that imaging is possible, the procedure proceeds to S408, and when it is determined that imaging is not possible, the procedure proceeds to S412. In S408, the captured image acquisition unit 430 causes the image capturing unit 310 to execute imaging.

In S410, the image information generation unit 432 generates the image information by using the captured image captured in S408. Then, the distribution information management unit 416 edits the distribution information so that the image information is included in the distribution information received in S402.

In S412, the vehicle-to-vehicle communication unit 414 and the communication relay unit 408 determine whether the distribution information can be transmitted. When the vehicle 300 is positioned in the distribution region indicated by the distribution region information included in the distribution information, and the vehicle as the transmission destination is present, the vehicle-to-vehicle communication unit 414 may determine that the distribution information can be transmitted. When the vehicle 300 is positioned in the distribution region indicated by the distribution region information included in the distribution information, and the communication terminal 500 as the transmission destination is present, the communication relay unit 408 may determine that the distribution information can be transmitted. When it is determined that the transmission is possible, the distribution information is transmitted (S414).

In S416, the communication apparatus 400 determines whether to end the advertisement distribution processing. When it is determined not to end the processing, the procedure returns to S404, and when it is determined to end the processing, the processing is ended.

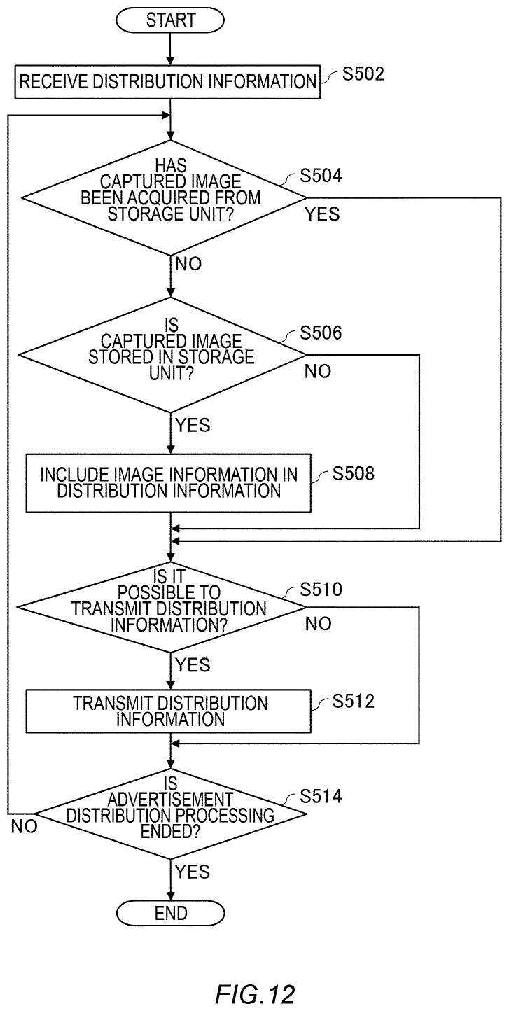

FIG. 12 illustrates an example of the flow of processing by the communication apparatus 400. In FIG. 12, a flow of transmitting the image information, which includes at least one of the captured image obtained by imaging the position related to the advertisement and the image-related information related to the captured image, and the distribution information to the outside will be described. Here, a case will be described in which the image capturing unit 310 continuously executes imaging and stores the captured image in association with an imaging position in the storage unit 402, and the captured image acquisition unit 430 acquires the captured image obtained by imaging the advertisement-related position from the storage unit 402.

In S502, the cellular communication unit 404 or the vehicle-to-vehicle communication unit 414 receives the distribution information. When the captured image obtained by imaging the advertisement-related position indicated by the base point information included in the distribution information has not been acquired (NO in S504), the procedure proceeds to S506, and when the captured image has been acquired (YES in S504), the procedure proceeds to S510.

In S506, the captured image acquisition unit 430 determines whether the captured image obtained by imaging the advertisement-related position is stored in the storage unit 402. When the captured image is stored, the procedure proceeds to S508, and when the captured image is not stored, the procedure proceeds to S510.

In S508, the image information generation unit 432 generates the image information by using the captured image stored in the storage unit 402 and obtained by imaging the advertisement-related position. Then, the distribution information management unit 416 edits the distribution information so that the image information is included in the distribution information received in S502.

In S510, the vehicle-to-vehicle communication unit 414 and the communication relay unit 408 determine whether the distribution information can be transmitted. When the vehicle 300 is positioned in the distribution region indicated by the distribution region information included in the distribution information, and the vehicle as the transmission destination is present, the vehicle-to-vehicle communication unit 414 may determine that the distribution information can be transmitted. When the vehicle 300 is positioned in the distribution region indicated by the distribution region information included in the distribution information, and the communication terminal 500 as the transmission destination is present, the communication relay unit 408 may determine that the distribution information can be transmitted. When it is determined that the transmission is possible, the distribution information is transmitted (S512).

In S514, the communication apparatus 400 determines whether to end the advertisement distribution processing. When it is determined not to end the processing, the procedure returns to S504, and when it is determined to end the processing, the processing is ended.

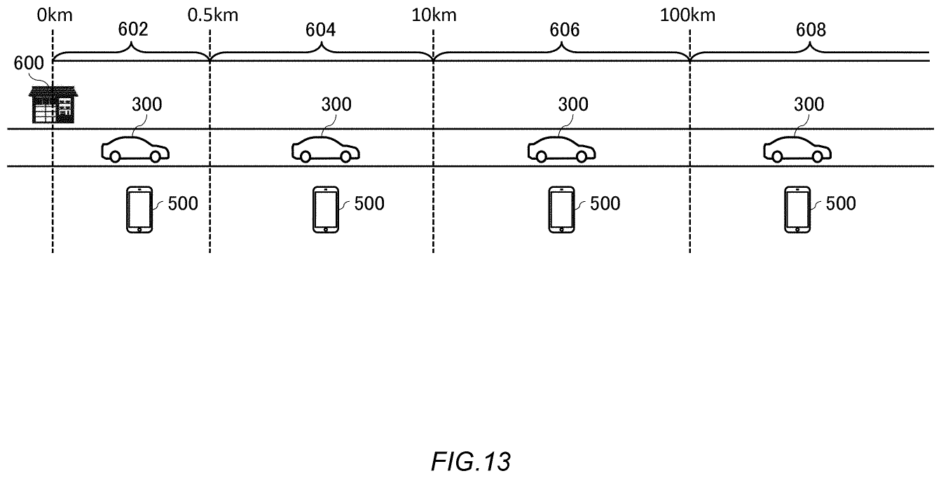

FIG. 13 schematically illustrates an example of a display area 602, an infection area 604, a non-infection area 606, and a sterilization area 608 with respect to an advertisement-related position 600. FIG. 13 illustrates a case where the advertisement-related position 600 is the store position of a soba restaurant that is the advertiser.

The display area 602 may be an example of the display region. The display area 602 may be an area within a predetermined range from the advertisement-related position 600. In the example illustrated in FIG. 13, the display area 602 is an area within a range of 0.5 km from advertisement-related position 600. In the display area 602, the vehicle 300 is permitted to transmit the distribution information to another vehicle 300 and to transmit the distribution information to the communication terminal 500. Furthermore, in the display area 602, the communication terminal 500 is permitted to display the stored distribution information.

The display area 602 and the infection area 604 may be an example of the distribution region. The distribution region may be an area within a predetermined range from the advertisement-related position 600. In the example illustrated in FIG. 13, the distribution region is an area within a range of 10 km from the advertisement-related position 600.

The conveyance of the distribution information between vehicles may be described as infection. The infection area 604 is an area within a predetermined range from the advertisement-related position 600 and is an area outside the display area 602. In the example illustrated in FIG. 13, the infection area 604 is an area within a range of 10 km from the advertisement-related position 600 and outside the display area 602. In the infection area 604, the vehicle 300 is permitted to transmit the distribution information to another vehicle 300 and to transmit the distribution information to the communication terminal 500. Note that in the infection area 604, the vehicle 300 may be restricted from transmitting the distribution information to the communication terminal 500. In the infection area 604, even when the distribution information is stored, the communication terminal 500 is restricted from displaying the distribution information. The restriction may be, for example, prohibiting.

The non-infection area 606 and the sterilization area 608 may be an example of a distribution restriction region in which the conveyance of the distribution information between vehicles is restricted. The distribution restriction region may be a region outside a predetermined range from the advertisement-related position 600. The distribution restriction region is, for example, a region outside the distribution region with reference to the advertisement-related position 600.

The non-infection area 606 is an area within a predetermined range from the advertisement-related position 600 and is an area outside the infection area 604. In the example illustrated in FIG. 13, the non-infection area 606 is an area within a range of 100 km from the advertisement-related position 600 and outside the infection area 604. In the non-infection area 606, the vehicle 300 is restricted from transmitting the distribution information to another vehicle 300 and from transmitting the distribution information to the communication terminal 500. In the non-infection area 606, even when the distribution information is stored, the communication terminal 500 is restricted from displaying the distribution information.

The sterilization area 608 may be an example of a discard region in which the distribution information is discarded. The discard region may be a region outside the distribution restriction region with reference to the advertisement-related position 600. Discarding the distribution information may be described as sterilization. The sterilization area 608 is an area outside the non-infection area 606. In the example illustrated in FIG. 13, the sterilization area 608 is an area 100 km or more away from the advertisement-related position 600. In the sterilization area 608, when the distribution information corresponding to the advertisement-related position 600 is stored, the vehicle 300 discards the distribution information. In the sterilization area 608, when the distribution information corresponding to the advertisement-related position 600 is stored, the communication terminal 500 discards the distribution information.

The restriction condition included in the distribution information may include distribution restriction region information indicating the distribution restriction region. Furthermore, the restriction condition included in the distribution information may include discard region information indicating the discard region.

The vehicle-to-vehicle communication unit 414 may determine whether to transmit the distribution information to another vehicle 300 based on the restriction condition included in the distribution information. When it is determined based on the restriction condition that the transmission of the distribution information to another vehicle 300 is not restricted, the vehicle-to-vehicle communication unit 414 transmits the distribution information to another vehicle 300, and when it is determined that the transmission is restricted, the vehicle-to-vehicle communication unit does not transmit the distribution information to another vehicle 300.

For example, when the position indicated by the position information acquired by the position information acquisition unit 420 is not positioned in the distribution restriction region, the vehicle-to-vehicle communication unit 414 executes the transmission of the distribution information to another vehicle 300, and when the position is positioned in the distribution restriction region, the vehicle-to-vehicle communication unit does not execute the transmission of the distribution information to another vehicle 300.

The communication relay unit 408 may determine whether to transmit the distribution information to the communication terminal 500 based on the restriction condition included in the distribution information. When it is determined based on the restriction condition that the transmission of the distribution information to the communication terminal 500 is not restricted, the communication relay unit 408 transmits the distribution information to the communication terminal 500, and when it is determined that the transmission is restricted, the communication relay unit does not transmit the distribution information to the communication terminal 500.

For example, when the position indicated by the position information acquired by the position information acquisition unit 420 is not positioned in the distribution restriction region, the communication relay unit 408 transmits the distribution information to the communication terminal 500, and when the position is positioned in the distribution restriction region, the communication relay unit does not transmit the distribution information to the communication terminal 500.

The restriction condition included in the distribution information may include display restriction region information indicating a display restriction region in which the display of the distribution information is restricted. The display restriction region may be a region outside the display region with reference to the advertisement-related position 600. The infection area 604, the non-infection area 606, and the sterilization area 608 may be an example of the display restriction region.

The display control unit 510 of the communication terminal 500 may perform control such that when the position indicated by the position information acquired by the position information acquisition unit 508 is not included in the display restriction region, the distribution information is displayed on the display unit 520, and when the position is included in the display restriction region, the distribution information is not displayed on the display unit 520.

The distribution information management unit 416 may determine whether to discard the distribution information based on the discard region information included in the distribution information. The distribution information management unit 416 may discard the distribution information from the storage unit 402 based on the position information acquired by the position information acquisition unit 420 and the discard region information included in the distribution information stored in the storage unit 402. The distribution information management unit 416 may be an example of a first discard execution unit.

For example, when the position indicated by the position information acquired by the position information acquisition unit 420 is positioned in the discard region indicated by the discard region information included in the distribution information, the distribution information management unit 416 deletes the distribution information from the storage unit 402.

The system 10 may be configured to be able to simultaneously discard the distribution information infecting the vehicle 300 and the communication terminal 500. For example, the advertiser terminal 200 transmits, to the server 100, a discard instruction to discard the distribution information requested to be distributed. The discard instruction may include the advertisement identification information.

The server 100 transmits the discard instruction to the vehicle 300 and the communication terminal 500. The server 100 may transmit the discard instruction to the vehicle 300 and the communication terminal 500 by the cellular communication. That is, the server 100 may transmit the discard instruction to the vehicle 300 and the communication terminal 500 in each place via the network 20 and the wireless base station 30.

In response to the reception of the discard instruction by the cellular communication unit 404, the distribution information management unit 416 discards, from the storage unit 402, the distribution information including the advertisement identification information included in the discard instruction. The cellular communication unit 404 may be an example of a second reception unit which receives the discard instruction. The distribution information management unit 416 may be an example of a second discard execution unit. In response to the reception of the discard instruction by the cellular communication unit 504, the control unit of the communication terminal 500 discards, from the storage unit 502, the distribution information including the advertisement identification information included in the discard instruction.

Accordingly, when it is considered that it is desired to delete the advertisement requested to be distributed, for example, when a soba restaurant requests the advertisement distribution of a lunch service, but the lunch service of the day is sold out, it is possible to simultaneously stop the conveyance and display of the advertisement. Further, by transmitting the discard instruction by the cellular communication, it is possible to cause the plurality of vehicles 300 and the communication terminal 500 to discard the distribution information in a short time as compared with a case where the transmission is performed by the vehicle-to-vehicle communication.

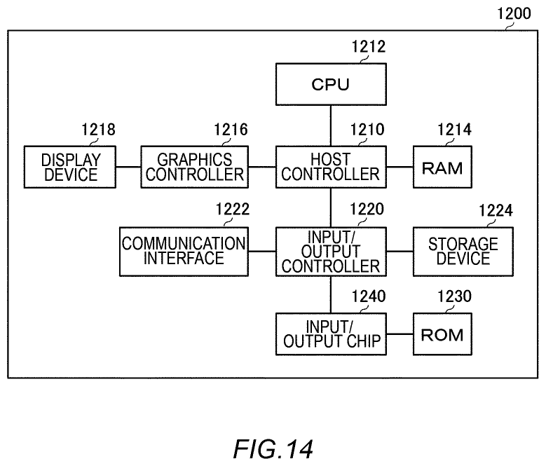

FIG. 14 schematically illustrates an example of a hardware configuration of a computer 1200 which functions as the server 100, the communication apparatus 400, or the communication terminal 500. A program installed in the computer 1200 can cause the computer 1200 to function as one or more “units” of the apparatus according to the above-described embodiment, or cause the computer 1200 to execute an operation or one or more “units” associated with the apparatus according to the above-described embodiment, and/or cause the computer 1200 to execute a process or a step of the process according to the above-described embodiment. Such programs may be executed by a CPU 1212 to cause the computer 1200 to perform certain operations associated with some or all of the blocks in the flowcharts and block diagrams described in the present specification.

The computer 1200 according to the present embodiment includes the CPU 1212, a RAM 1214, and a graphic controller 1216, which are interconnected by a host controller 1210. The computer 1200 also includes input/output units such as a communication interface 1222, a storage device 1224, and an IC card drive, which are connected to the host controller 1210 via an input/output controller 1220. The storage device 1224 may be a hard disk drive, a solid state drive, or the like. The computer 1200 also includes a ROM 1230 and a legacy input/output unit such as a touch panel, which are connected to the input/output controller 1220 via an input/output chip 1240.

The CPU 1212 operates according to the programs stored in the ROM 1230 and the RAM 1214, thereby controlling each unit. The graphic controller 1216 acquires the image data generated by the CPU 1212 in a frame buffer or the like provided in the RAM 1214 or in itself and causes the image data to be displayed on a display device 1218. The computer 1200 may not include the display device 1218, and in that case, the graphic controller 1216 causes the image data to be displayed on an external display device.

The communication interface 1222 communicates with other electronic devices via a wireless communication network. The storage device 1224 stores programs and data used by the CPU 1212 in the computer 1200. The IC card drive reads program and data from the IC card and/or writes the program and data to the IC card.

The ROM 1230 stores therein a boot program or the like executed by the computer 1200 at the time of activation and/or a program depending on the hardware of the computer 1200. The input/output chip 1240 may also connect various input/output units to the input/output controller 1220 via a USB port or the like.

The program is provided by a computer-readable storage medium such as an IC card. The program is read from the computer-readable storage medium, installed in the storage device 1224, the RAM 1214, or the ROM 1230, which is also an example of the computer-readable storage medium, and executed by the CPU 1212. The information processing described in these programs is read by the computer 1200 and provides cooperation between the programs and the various types of hardware resources. The apparatus or method may be configured by implementing the operation or processing of information according to the use of the computer 1200.

For example, when communication is performed between the computer 1200 and an external device, the CPU 1212 may execute a communication program loaded in the RAM 1214 and instruct the communication interface 1222 to perform communication processing based on the processing described in the communication program. Under the control of the CPU 1212, the communication interface 1222 reads transmission data stored in a transmission buffer region provided in a recording medium such as the RAM 1214, the storage device 1224, or the IC card, transmits the read transmission data to the network, or writes reception data received from the network in a reception buffer region or the like provided on the recording medium.

The CPU 1212 may cause the RAM 1214 to read all or a necessary portion of a file or a database stored in an external recording medium such as the storage device 1224 or the IC card and may execute various types of processing on data on the RAM 1214. Next, the CPU 1212 may write back the processed data to the external recording medium.

Various types of information such as various types of programs, data, tables, and databases may be stored in a recording medium and subjected to information processing. The CPU 1212 may execute various types of processing, which is described throughout the present disclosure and includes various types of operations designated by an instruction sequence of a program, information processing, condition determination, conditional branching, unconditional branching, information retrieval/replacement, and the like, on the data read from the RAM 1214 and writes back the results to the RAM 1214. Furthermore, the CPU 1212 may search for information in a file, a database, or the like in the recording medium. For example, when a plurality of entries each having the attribute value of a first attribute associated with the attribute value of a second attribute is stored in the recording medium, the CPU 1212 may search for an entry matching a condition in which the attribute value of the first attribute is designated from the plurality of entries, read the attribute value of the second attribute stored in the entry, and thus acquire the attribute value of the second attribute associated with the first attribute satisfying a predetermined condition.

The programs or software modules described above may be stored in a computer-readable storage medium on the computer 1200 or near the computer 1200. Furthermore, a recording medium such as a hard disk or a RAM provided in a server system connected to a dedicated communication network or the Internet can be used as the computer-readable storage medium, thereby providing the program to the computer 1200 via the network.

The blocks in the flowcharts and block diagrams in the above-described embodiment may represent the steps of a process in which an operation is performed or the “units” of an apparatus responsible for executing the operation. Specific steps and “units” may be implemented by a dedicated circuit, a programmable circuit provided with a computer-readable instruction stored on the computer-readable storage medium, and/or a processor provided with the computer-readable instruction stored on the computer-readable storage medium. The dedicated circuit may include a digital and/or analog hardware circuit, and may include an integrated circuit (IC) and/or a discrete circuit. For example, the programmable circuit may include a reconfigurable hardware circuit which includes logical AND, logical OR, exclusive OR, NAND, NOR, and other logical operations, flip-flops, registers, and memory elements, such as a field programmable gate array (FPGA) and a programmable logic array (PLA).

The computer-readable storage medium may include any tangible device capable of storing instructions for execution by a suitable device, so that the computer-readable storage medium having the instructions stored thereon includes a product including instructions that can be executed to create means for executing the operations designated in the flowcharts or block diagrams. Examples of the computer-readable storage medium may include an electronic storage medium, a magnetic storage medium, an optical storage medium, an electromagnetic storage medium, a semiconductor storage medium, and the like. More specific examples of the computer-readable storage medium may include a floppy (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disc read-only memory (CD-ROM), a digital versatile disk (DVD), a Blu-Ray (registered trademark) disk, a memory stick, an integrated circuit card, and the like.

The computer-readable instruction may include any one of a source code or an object code written in any combination of one or more programming languages including assembler instructions, instruction-set-architecture (ISA) instructions, machine instructions, machine-dependent instructions, microcode, firmware instructions, state-setting data, or an object oriented programming language such as Smalltalk (registered trademark), JAVA (registered trademark), and C++, and a conventional procedural programming language such as the “C” programming language or similar programming languages.

The computer-readable instruction may be provided for a processor of a general purpose computer, a special purpose computer, or another programmable data processing apparatus, or a programmable circuit locally or via a local area network (LAN) or a wide area network (WAN) such as the Internet in order that the processor of the general purpose computer, the special purpose computer, or another programmable data processing apparatus, or the programmable circuit executes the computer-readable instruction to generate a means for executing the operations designated in the flowcharts or block diagrams. Examples of the processor include a computer processor, a processing unit, a microprocessor, a digital signal processor, a controller, a microcontroller, and the like.

While the embodiments of the present invention have been described, the technical scope of the invention is not limited to the above described embodiments. It is apparent to persons skilled in the art that various alterations or improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, specification, or diagrams can be performed in any order as long as the order is not indicated by “prior to,” “before,” or the like and as long as the output from a previous process is not used in a later process. Even if the process flow is described using phrases such as “first” or “next” in the claims, specification, or diagrams, it does not necessarily mean that the process must be performed in this order.

### EXPLANATION OF REFERENCES

10 system, 20 network, 30 wireless base station, 40 access point, 100 server, 200 advertiser terminal, 202 advertisement base point, 204 advertisement area, 210 distribution information, 220 report information, 300 vehicle, 302 vehicle position, 304 wireless communication area, 306 wireless communication area, 310 image capturing unit, 320 vehicle, 330 vehicle, 400 communication apparatus, 402 storage unit, 404 cellular communication unit, 406 terminal communication unit, 408 communication relay unit, 410 communication control unit, 412 AP communication unit, 414 vehicle-to-vehicle communication unit, 416 distribution information management unit, 420 position information acquisition unit, 422 speed information acquisition unit, 430 captured image acquisition unit, 432 image information generation unit, 500 communication terminal, 502 storage unit, 504 cellular communication unit, 506 Wi-Fi communication unit, 508 position information acquisition unit, 510 display control unit, 520 display unit, 600 advertisement-related position, 602 display area, 604 infection area, 606 non-infection area, 608 computer, 1200 sterilization area, 1210 host controller, 1212 CPU, 1214 RAM, 1216 graphic controller, 1218 display device, 1220 input/output controller, 1222 communication interface, 1224 storage device, 1230 ROM, 1240 input/output chip

What is claimed is:

1. A communication apparatus comprising:
a position information acquisition unit configured to acquire moving object position information regarding a current position of a first moving object on which the communication apparatus is mounted;
a reception unit configured to receive distribution information;
a transmission unit configured to transmit the distribution information to a second moving object different from the first moving object; and
a communication relay unit configured to relay communication between an external terminal positioned outside the first moving object and an external network, wherein
the distribution information includes distribution region information regarding a distribution region to which an advertisement is distributed,
the transmission unit is configured to transmit the distribution information to the second moving object when a position indicated by the moving object position information is included in the distribution region, and
the communication relay unit is configured to transmit the distribution information to the external terminal when the position indicated by the moving object position information is included in the distribution region.

2. The communication apparatus according to claim 1, wherein
the distribution information includes advertisement content including at least one of a text and an image indicating content of the advertisement.

3. The communication apparatus according to claim 1, wherein
the distribution information includes display region information indicating a geographic region in which the advertisement is displayed on a display unit of the external terminal.

4. The communication apparatus according to claim 2, wherein
the distribution information includes display region information indicating a geographic region in which the advertisement is displayed on a display unit of the external terminal.

5. The communication apparatus according to claim 1, wherein
the transmission unit is configured to transmit the distribution information to the second moving object via communication between moving objects.

6. The communication apparatus according to claim 2, wherein
the transmission unit is configured to transmit the distribution information to the second moving object via communication between moving objects.

7. The communication apparatus according to claim 1, wherein
the reception unit is configured to receive the distribution information from a third moving object different from the first moving object.

8. The communication apparatus according to claim 2, wherein
the reception unit is configured to receive the distribution information from a third moving object different from the first moving object.

9. The communication apparatus according to claim 7, wherein
the reception unit is configured to receive the distribution information from the third moving object via communication between moving objects.

10. The communication apparatus according to claim 1, wherein
the external network includes a cellular network, and
the transmission unit is configured to transmit the distribution information to the second moving object by using a communication system with a lower communication cost than a cellular communication system.

11. The communication apparatus according to claim 2, wherein
the external network includes a cellular network, and
the transmission unit is configured to transmit the distribution information to the second moving object by using a communication system with a lower communication cost than a cellular communication system.

12. The communication apparatus according to claim 10, wherein
the communication relay unit is configured to transmit the distribution information to the external terminal by using a communication system with a lower communication cost than the cellular communication system.

13. The communication apparatus according to claim 1, comprising:
a distribution information management unit configured to manage the distribution information received by the reception unit, wherein
the distribution information includes conveyance path information including information regarding a moving object to which the distribution information has been conveyed,
the distribution information management unit is configured to add, to the conveyance path information of the distribution information received by the reception unit, moving object identification information for identifying the first moving object, and
the transmission unit is configured to transmit, to the second moving object, the distribution information obtained by adding the moving object identification information of the first moving object to the conveyance path information by the distribution information management unit.

14. The communication apparatus according to claim 2, comprising:
a distribution information management unit configured to manage the distribution information received by the reception unit, wherein
the distribution information includes conveyance path information including information regarding a moving object to which the distribution information has been conveyed,
the distribution information management unit is configured to add, to the conveyance path information of the distribution information received by the reception unit, moving object identification information for identifying the first moving object, and
the transmission unit is configured to transmit, to the second moving object, the distribution information obtained by adding the moving object identification information of the first moving object to the conveyance path information by the distribution information management unit.

15. The communication apparatus according to claim 13, wherein
the distribution information includes advertisement identification information, and
the distribution information management unit is configured to manage a history of the advertisement identification information of the distribution information received by the reception unit and to, when the advertisement identification information of the distribution information received by the reception unit is included in the history, delete the distribution information.

16. The communication apparatus according to claim 13, wherein
the distribution information includes advertisement identification information, and
the distribution information management unit is configured to notify the second moving object of the advertisement identification information of the distribution information received by the reception unit and causes the transmission unit to transmit the distribution information to the second moving object upon response from the second moving object.

17. The communication apparatus according to claim 1, wherein
the first moving object and the second moving object are vehicles.

18. A system comprising:
the external terminal; and
the communication apparatus according to claim 1.

19. The system according to claim 18, wherein
the distribution information includes advertisement content including at least one of a text and an image indicating content of the advertisement and includes display region information indicating a geographic region in which the advertisement is displayed on a display unit of the external terminal, and
the external terminal includes:
the display unit;
a terminal storage unit configured to store the distribution information received from the communication apparatus; and
a display control unit configured to cause the advertisement content included in the distribution information to be displayed on the display unit when the external terminal is positioned in a geographic region indicated by the display region information included in the distribution information.

20. A non-transitory computer-readable storage medium for causing a computer to function as a communication apparatus, the communication apparatus comprising:
a position information acquisition unit configured to acquire moving object position information regarding a current position of a first moving object on which the communication apparatus is mounted;
a reception unit configured to receive distribution information;
a transmission unit configured to transmit the distribution information to a second moving object different from the first moving object; and
a communication relay unit configured to relay communication between an external terminal positioned outside the first moving object and an external network, wherein
the distribution information includes distribution region information regarding a distribution region to which an advertisement is distributed,
the transmission unit is configured to transmit the distribution information to the second moving object when a position indicated by the moving object position information is included in the distribution region, and
the communication relay unit is configured to transmit the distribution information to the external terminal when the position indicated by the moving object position information is included in the distribution region.
